(19) United States
(12) Patent Application Publication
(10) Pub. No.: US 2024/0376374 A1
(43) Pub. Date: Nov. 14, 2024

(54) DUAL LIGHT EMITTING MATERIAL, AND SECURITY METHOD USING THE SAME

(71) Applicant: UIF (University Industry Foundation), Yonsei University, Seoul (KR)

(72) Inventors: Cheol Min PARK, Seoul (KR); Jin Woo OH, Seoul (KR); Hyo Won HAN, Seoul (KR); Hyeok Jung LEE, Seoul (KR)

(73) Assignee: UIF (University Industry Foundation), Yonsei University, Seoul (KR)

(21) Appl. No.: 18/656,032

(22) Filed: May 6, 2024

(30) Foreign Application Priority Data
May 9, 2023 (KR) 10-2023-0059625
Jun. 21, 2023 (KR) 10-2023-0079508

(51) Int. Cl. C09K 11/02; C09K 11/06; G06K 19/18; G09F 3/03

(52) U.S. Cl. CPC C09K 11/02; C09K 11/06; G06K 19/18; G09F 3/0376

(57) ABSTRACT

Proposed is a dual-light-emitting material that includes a porous framework composed of a metal ion and an organic ligand, an insert body placed in a cavity of the porous framework, and a nanocrystal containing the metal ion of the porous framework, wherein the organic ligand is configured to emit room-temperature organic phosphorescence (RT-OP) and the nanocrystal is configured to emit fluorescence.

### CROSS REFERENCE TO RELATED APPLICATION

The present application claims priority to Korean Patent Application Nos. 10-2023-0059625, filed on May 9, 2023, and 10-2023-0079508, filed on Jun. 21, 2023, the entire contents of which are incorporated herein for all purposes by this reference.

### BACKGROUND

### Technical Field

The present disclosure relates to a technology for synthesizing and utilizing a duel-light-emitting material and, more specifically, to a technology for synthesizing and utilizing a duel-light-emitting material for high-performance optical pattern encryption.

In addition, the present disclosure relates to a two-dimensional security method using a duel-light-emitting material, a duel-light-emitting encryption cube, a method to fabricate the dual-light-emitting encryption cube, and a three-dimensional security method using the dual-light-emitting encryption cube and, more specifically, to a two-dimensional security method using a camouflage ink made of a fluorescent material and a real ink made of a duel-light-emitting material that is both fluorescent and phosphorescent, a duel-light-emitting encryption cube where the entire cube emits fluorescence and after fluorescence luminescence only the cube branches that form a meaningful pattern emit phosphorescence, a method to fabricate the duel-light-emitting encryption cube that has a three-dimensional pattern structure where information varies depending on the position and angle of view using the duel-light-emitting encryption cube, and a three-dimensional security method using the duel-light-emitting encryption cube that encrypts and decrypts with a three-dimensional pattern structure of the duel-light-emitting encryption cube.

### Description of the Related Art

Over the past decade, cutting-edge technologies have witnessed rapid development and completely transformed the way people connect and communicate with each other, thereby realizing a “hyper-connected society”. However, this connected society has resulted in a gradual degradation in information security, including privacy, confidentiality, and secrecy, which is often valued by individuals. Therefore, it is the most important to ensure confidential data security based on an encryption system. Accordingly, information encryption technologies based on electrical or optical encryption have been widely developed. Among the optical encryption technologies including technologies based on chromism, structural color, and metasurface holography, the technologies based on photoluminescence (PL) have received special attention because of the self-luminescence capability, high brightness, and efficiency, in addition to the low probability of being hacked by digital computing systems.

Although PL encryption technologies based on organic fluorescent materials are widely widespread, room-temperature organic phosphorescence (RT-OP), which originates from the radiation transition of excitons from the triplet excitation state to the ground state, has also received considerable attention in a variety of fields such as displays, bioimaging, document security, encryption, and anti-counterfeiting. To achieve efficient and stable RT-OP, the large-scale dissipation of excitons through non-radiative processes, which hinders efficient energy transfer, should be minimized.

Korean Patent Application Publication No. 10-2018-0093135, which is cited herein as a related art document, discloses a security structure including phosphorescent and fluorescent compositions in this application.

As shown in FIGS. 1A to 1D of the accompanying drawings, in the related art technology, one or more patterns 15 are printed by a phosphorescent composition 12 as shown in FIG. 1B, and a fluorescent composition 13 is printed thereon as shown in FIG. 1A. Since the phosphorescent composition 12 and the fluorescent composition 13 may be selected to emit light by luminescence under ultraviolet excitation of a wavelength of 254 nm and have the same color at substantially the same intensity, a structure 10 is shown to have substantially a uniform shape under ultraviolet luminescence and an observer is unable to distinguish the patterns 15 formed of the phosphorescent composition 12 as shown in FIG. 1A.

After ultraviolet luminescence is dissipated, the layer of the fluorescent composition 13 stops luminescence, and the patterns 15 compartmentalized by phosphorescent composition 12 appear and become visible as shown in FIG. 1B.

In addition, it is possible to use the phosphorescent composition 12 and the fluorescent composition 13 that emit different colors by luminescence. In this case, the two compositions 12 and 13 under ultraviolet light with a wavelength of 254 nm may emit different lights by the additive synthesis where the compositions 12 and 13 are overlapped, and show patterns 15 appearing as a first color on the colored background 16 that appears in another color, which is that of the fluorescence of the fluorescent composition 13 in the example described in FIG. 1C. For example, while using a fluorescent composition 13 that emits blue light by fluorescence and a phosphorescent composition 12 that emits yellow light by phosphorescence under ultraviolet light, the patterns 15 appear white by additive synthesis where the compositions are overlapped, while the background 16 appears blue. When ultraviolet luminescence is dissipated, the patterns 15 appear yellow during the afterglow time of the phosphorescent composition 12 as shown in FIG. 1D.

However, the conventional method disclosed in the related art document has a problem in that the secured information may be easily exposed by irradiation of ultraviolet rays (IU) when the form of the security is known to use phosphorescent or fluorescent compositions.

In addition, the conventional method disclosed in the related art document has a problem in that even encrypted information may be cracked to be exposed by computer equipment with astronomical computational speeds.

### DOCUMENTS OF RELATED ART

(Patent Document 1) Korean Patent Application Publication No. 10-2018-0093135 (Publication Date: Aug. 20, 2018)

### SUMMARY

One objective of the present disclosure is to develop a dual self-luminescent material where phosphorescence and fluorescence are simultaneously exhibited.

Another objective of the present disclosure is to provide a dual-light-emitting material for high-performance optical pattern encryption.

Another objective of the present disclosure is to provide a dual-light-emitting material that utilizes fluorescent host-guest interactions.

Another objective of the present disclosure is to provide a two-dimensional security method utilizing a dual-light-emitting material that enhances security by disguising real information with other information.

Another objective of the present disclosure is to provide a dual-light-emitting encryption cube that encrypts in a three-dimensional pattern structure using a dual-light-emitting material, thereby providing reliable security even for cracking using a high-performance computer.

Another objective of the present disclosure is to provide a method of fabricating a dual-light-emitting encryption cube that encrypts in a three-dimensional pattern structure using a dual-light-emitting material, thereby providing reliable security even for cracking using a high-performance computer.

Another objective of the present disclosure is to provide a three-dimensional security method using a dual-light-emitting encryption cube that encrypts and decrypts in a three-dimensional pattern structure of a dual-light-emitting encryption cube.

Although the objectives of the present disclosure have been described in detail, not only the objectives but also the additional objectives derived from the process of achieving the objectives mentioned above may be included in the scope of the objectives to be achieved in the present disclosure.

According to one aspect of the present disclosure, provided is a dual-light-emitting material that includes a porous framework composed of a metal ion and an organic ligand, an insert body placed in a cavity of the porous framework, and a nanocrystal containing the metal ion of the porous framework, wherein the organic ligand is configured to emit room-temperature organic phosphorescence (RT-OP) and the nanocrystal is configured to emit fluorescence.

According to another aspect of the present disclosure, a method of fabricating a dual-light-emitting material is provided, the method that includes a step (S100) of preparing a first solution where the organic ligand and the insert body are dissolved, a step (S200) of forming a porous framework containing the insert body by mixing a metal ion solution with the first solution, a step (S300) of forming the dual-light-emitting material by mixing a nanocrystal precursor solution with a suspension including the porous framework containing the insert body, wherein the organic ligand is configured to emit room-temperature organic phosphorescence (RT-OP) and the nanocrystal is configured to emit fluorescence.

According to another aspect of the present disclosure, a two-dimensional security method using a fluorescent-phosphorescent dual-light-emitting material is provided, the method that includes an encryption process composed of attaching a masking tape to a substrate, exposing an area for encryption information to be printed by patterning the masking tape, printing on the exposed area the encryption information where real information is combined with fake information by printing real information in a ink mixed by the fluorescent-phosphorescent dual-light-emitting material as well as by printing fake information associated with real information in a ink by a fluorescent material, and removing the masking tape, and a decryption process composed of emitting fluorescence by radiating ultraviolet rays to the encryption information for a predetermined time, and displaying real information through phosphorescence of the real information when the luminescence of fake information stops after irradiation of the ultraviolet rays stops.

According to another aspect of the present disclosure, a dual-light-emitting encryption cube having a three-dimensional encryption pattern by dual luminescence of fluorescence and phosphorescence includes eight vertices of a cube and twelve cube branches connecting the eight vertices, wherein an information branch of the encryption cube included in the three-dimensional encryption pattern is composed of a fluorescent-phosphorescent filament, and a camouflage branch of the encryption cube not included in the three-dimensional encryption pattern is composed of a fluorescent filament according to the predetermined three-dimensional encryption pattern, wherein the information branch and the camouflage branch are disposed in any one of six external branches forming a cube centered on the vertices and six internal branches connecting the vertex to each contact point of the six external branches.

According to another aspect of the present disclosure, a method of fabricating a dual-light emitting encryption cube capable of dual luminescence of fluorescence and phosphorescence is provided, the method that includes a step of mixing a fluorescent light-emitting material with a polymer solvent to form a fluorescent solution, mixing a fluorescent-phosphorescent dual-light-emitting material with the polymer solvent to form a fluorescent-phosphorescent solution, and respectively filling the fluorescent solution and the fluorescent-phosphorescent solution into an engraved pattern of a separately patterned mold, a step of drying the fluorescent solution and the fluorescent-phosphorescent solution filled in the mold at room temperature only to form a fluorescent filament and a fluorescent-phosphorescent filament respectively, and a step of cutting the fluorescent filament and the fluorescent-phosphorescent filament as much as a predetermined cube branch length of the encryption cube, wherein an information branch of the encryption cube included in the three-dimensional encryption pattern is assembled with the fluorescent-phosphorescent filaments and a camouflage branch of the encryption cube not included in the three-dimensional encryption pattern is assembled with the fluorescent filaments according to a predetermined three-dimensional encryption pattern.

According to another aspect of the present disclosure, in a three-dimensional security method using a dual-light-emitting encryption cube that is three-dimensionally patterned with a fluorescent light-emitting material and a fluorescent-phosphorescent dual-light-emitting material, the encryption cube is generated as a patterned encryption cube by assembling the cube branch using fluorescent-phosphorescent dual-light-emitting material with respect to the information branch of the encryption cube forming the three-dimensional encryption pattern and by assembling the cube branch using fluorescent light-emitting material with respect to the camouflage branch of the encryption cube not included in the three-dimensional encryption pattern, and the three-dimensional security method may include a process of an encryption setting for setting a user's password according to a three-dimensional encryption pattern set between the user terminal and a security device, a process of inputting the user password at the user terminal, the process that includes a step of arranging the information branches and the camouflage branches in the correct positions centered on the vertices according to each encryption pattern of the patterned encryption cube while arranging sequentially the encryption cubes corresponding to the user password among the pre-patterned encryption cubes, a step of radiating ultraviolet rays to encryption cubes arranged sequentially according to the user password during a predetermined time, a step of photographing the encryption cubes arranged sequentially according to the encryption information after stopping the irradiation of the ultraviolet rays, a step of generating a password input information by binarizing the information branch and the camouflage branch of each photographed encryption cube, and a step of transmitting the generated password input information to the security device, and a process of decrypting the input user password in the security device, the process that includes a step of sequentially generating a three-dimensional encryption pattern of the encryption cube on the basis of the binary information of the user password transmitted from the user terminal, a step of calculating a matching rate by comparing the pattern of the user password registered in the encryption setting process with the generated three-dimensional encryption pattern of the encryption cube, and a step of releasing security and providing information as matching success when the matching rate is more than a predetermined value or transmitting a matching failure notification as matching failure when the matching rate is less than the predetermined value.

According to the present disclosure, a dual-light-emitting material may be obtained on the basis of fluorescent perovskite nanocrystals (NCs) embedded in porous metal-organic frameworks (MOFs) designed for fluorescent host-guest interactions.

In addition, the MOF containing the guest material may emit highly efficient blue phosphorescence and the perovskite NCs embedded in the MOF may emit characteristic green or red fluorescence under ultraviolet (UV) irradiation according to the present disclosure.

In addition, it may be possible to secure the luminescence stability of the phosphorescence through In-situ synthesis fixation according to the present disclosure.

In addition, high-brightness fluorescence may be implemented through post-processing synthesis according to the present disclosure.

In addition, there may be an effect of increasing security by attracting real information to other information by a two-dimensional security method using a dual-light-emitting material according to a preferred exemplary embodiment of the present disclosure.

In addition, it may be possible to provide reliable security against cracking using a high-performance computer by a three-dimensional pattern structure that provides different information depending on the position and angle of view according to a dual-light-emitting encryption cube, a method of fabricating a dual-light-emitting encryption cube, and a three-dimensional security method using a dual-light-emitting encryption cube according to a preferred exemplary embodiment of the present disclosure.

Although the effects of the present disclosure have been described in detail above, the present disclosure may include not only the above-described effects but also additional effects derived from the process of obtaining the above-described effects as effects of the present disclosure.

### BRIEF DESCRIPTION OF THE DRAWINGS

FIGS. 1A to 1D are views showing exemplary diagrams of a security structure according to a related art technology.

FIGS. 2A to 2H are views showing the synthesis and characteristics of MOF particles according to an exemplary embodiment of the present disclosure and specifically, as follows:

FIG. 2A is a view showing a schematic diagram of the synthesis process for Pb-MOF, Ph MOF, and Fl-Ph MOF samples;

FIG. 2B is a view showing an SEM image of a Pb-MOF;

FIG. 2C is a view showing an SEM image of a Ph MOF (1:6);

FIG. 2D is a view showing the actual CA loading amount (percentage) of the Ph MOF based on thermogravimetric analysis;

FIG. 2E is a view showing the normalized XRD peak in the plane of CA (200) for Ph MOF having a CA loading amount different from that of Pb-MOF;

FIG. 2F is a view showing O—H bond stretching vibrational peaks obtained from FTIR spectra of CA, Pb-MOF, and Ph MOF with different CA loading amounts;

FIG. 2G is a view showing C—O bond stretching vibrational peaks obtained from FTIR spectra of CA, Pb-MOF, and Ph MOF with different CA loading amounts;

FIG. 2H is a view showing an N₂ adsorption/desorption isotherm of Pb-MOF and Ph MOF with different CA loading amounts at 77 K.

FIGS. 3A to 3H are views showing photophysical properties of Ph MOF at room temperature according to an exemplary embodiment of the present disclosure, specifically as follows:

FIG. 3A is a view showing a photograph of Pb-MOF, and Ph MOFs with different CA loading amounts, under UV light irradiation (254 nm) and after different intervals after turning off the UV lamp (scale bar: 1 cm);

FIG. 3B is a view showing an energy-transfer mechanism for deep-blue (405 nm) phosphorescence of Ph MOF at room temperature;

FIG. 3C is a view showing steady-state RT-OP spectra for Pb-MOF and Ph MOFs with different CA loading amounts;

FIG. 3D is a view showing a normalized intensity of the 405 nm emission for Pb-MOF, and Ph MOFs with different CA loading amounts;

FIG. 3E is a view showing an RT-OP on/off switching cycle test (scale bar: 5 mm) using a Ph MOF (1:6) sample;

FIG. 3F is a view showing a time-resolved phosphorescence decay curve of Pb-MOF and Ph MOFs with different CA loading amounts;

FIG. 3G is a view showing a phosphorescence intensity (scale bar: 1 mm) of a Ph MOF (1:6) sample and a TMA/CA/H₂O mixture exposed to an atmosphere with 10% RH over time;

FIG. 3H is a view showing a stability of a phosphorescence intensity of Ph MOF (1:6) sample in a variety of solvents.

FIGS. 4A to 4I are views showing the characteristics of MAPbBr₃ and MAPbBrₓI₃₋ₓ perovskite NC-embedded Fl-Ph MOFs according to an exemplary embodiment of the present disclosure, more particularly as follows:

FIG. 4A is a view showing a photograph (scale bar: 1 cm) of the Fl-Ph MOFs under daylight, under UV light (254 nm), and after turning off the UV lamp;

FIG. 4B is a view showing an SEM image of Fl-Ph MOFs;

FIG. 4C is a view showing an SEM-EDX elemental mapping image (Pb and Br mapping) of Ph MOF and Fl-Ph MOF;

FIG. 4D is a view showing an HR-TEM image of the Fl-Ph MOF and an FFT pattern from the HR-TEM image;

FIG. 4E is a view showing an XRD pattern of the Ph MOFs, MAPbBr₃(bulk), and Fl-Ph MOFs;

FIG. 4F is a view showing PL spectra of the Fl-Ph MOF under 254 nm excitation;

FIG. 4G is a view showing a reversible PL and RT-OP switching test (scale bar: 5 mm) using Fl-Ph MOFs;

FIG. 4H is a view showing the proposed mechanism of dual luminescence of Fl-Ph MOFs using relative frontier orbital energy;

FIG. 4I is a view showing a photograph of a red fluorescent Fl-Ph MOF using an iodine-containing perovskite (MAPbBrₓI₃₋ₓ) NC under daylight, under UV light (254 nm), and after turning off the UV lamp.

FIG. 5 is a view showing a flowchart of an encryption process and a decryption process of a two-dimensional security method using a fluorescent-phosphorescent dual-light-emitting material according to one preferred exemplary embodiment of the present disclosure.

FIGS. 6A to 6D are views showing an exemplary diagram for describing a principle of encryption and a principle of decryption according to a two-dimensional security method using a dual-light-emitting material according to a preferred exemplary embodiment of the present disclosure.

FIG. 7 is a view showing a comparative example describing experimental results on the decrypting results for each wavelength of ultraviolet rays applied to a two-dimensional security method using a dual-light-emitting material according to a preferred exemplary embodiment of the present disclosure.

FIGS. 8A to 8C are views showing a method of fabricating a dual-light-emitting encryption cube according to a preferred exemplary embodiment of the present disclosure.

FIG. 9 is an exemplary diagram showing a three-dimensional encryption pattern structure according to a preferred exemplary embodiment of the present disclosure.

FIG. 10 is a view showing a structural diagram of a dual-light-emitting encryption cube having a three-dimensional encryption pattern structure according to a preferred exemplary embodiment of the present disclosure.

FIG. 11 is a view showing an exemplary diagram of another figure having a three-dimensional encryption pattern structure according to a preferred exemplary embodiment of the present disclosure.

FIG. 12 is an exemplary diagram showing a process of decrypting in an application of a security system by a three-dimensional encryption pattern according to a preferred exemplary embodiment of the present disclosure.

FIG. 13 is an exemplary diagram showing a scene in which an encryption cube is disposed and photographed after each of ultraviolet irradiation and interruption.

FIG. 14 is an exemplary diagram showing the fluorescence and phosphorescence luminescence when the three-dimensional encryption pattern matches and when the three-dimensional encryption pattern does not match.

FIG. 15 is a view showing a principle for describing the number of cases according to the position and time of the encryption cube in a security system using a three-dimensional encryption pattern according to a preferred exemplary embodiment of the present disclosure.

FIG. 16 is an exemplary diagram showing the calculation of security efficiency in a security system using a three-dimensional encryption pattern according to a preferred exemplary embodiment of the present disclosure.

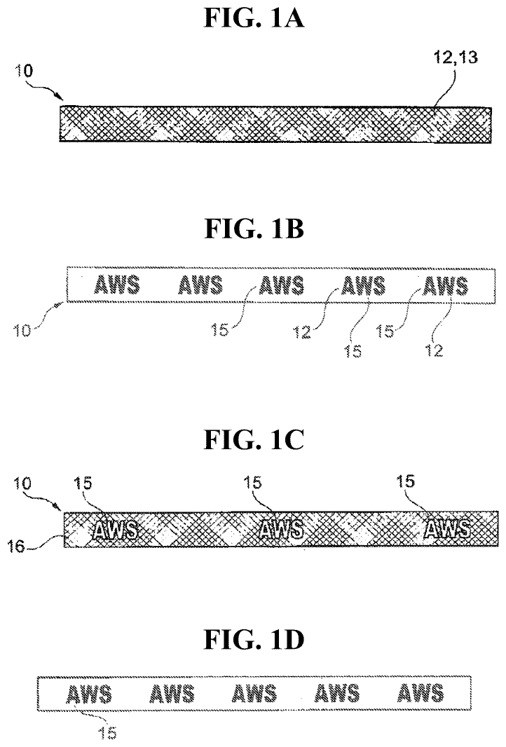

### DETAILED DESCRIPTION OF THE DISCLOSURE

The above objectives, other objectives, features and advantages will be easily understood through the following preferred exemplary embodiments related to the accompanying drawings. However, it may not be limited to the exemplary embodiments described herein and may be embodied in other forms. Rather, the exemplary embodiments introduced herein may be provided so that the disclosed content will be thorough and complete and the technical ideas may be sufficiently conveyed to those skilled in the art.

In describing each drawing, similar reference numerals may be used for similar components. In the accompanying drawings, the dimensions of the structures may be enlarged than the actual ones for clarity of the present disclosure. Terms such as first, second, and the like may be used to describe a variety of components, but the components should not be limited by the above terms. The terms may be used only for the purpose of distinguishing one component from another component. For example, a first component may be referred to as a second component without departing from the scope of the present disclosure, and similarly, a second component may be referred to as a first component. Singular expressions may include plural expressions unless the context clearly indicates otherwise.

In this specification, the term such as “include” or “have” may be intended to specify the presence of a feature, number, step, operation, component, part or combination thereof described in the specification, and it should be understood that the presence or additional possibilities of one or more other features or numbers, steps, operations, components, parts, or combinations thereof are not excluded in advance. In addition, when a part of a layer, membrane, region, plate, etc. is said to be “on” another part, this may include not only being “directly above” the other part, but also cases where there is another part in between. Conversely, when a part of a layer, membrane, region, plate, etc. is said to be “below” another part, this may include not only being “immediately below” the other part, but also cases where there is another part in between.

Unless otherwise stated, all numbers, values, and/or expressions used herein expressing quantities of components, reaction conditions, polymer compositions, and formulations should be understood in all cases as being qualified by the term “approximately”, since these numbers are essentially approximations reflecting various uncertainties in the measurement resulting from obtaining these values among others. In addition, when a numerical range is disclosed in the present disclosure, this range may be continuous and include all values from the minimum value in this range to the maximum value including the maximum value unless otherwise indicated. Furthermore, when this range refers to an integer, all integers including the minimum value to the maximum value including the maximum value unless otherwise indicated are included.

According to an aspect of the present disclosure, provided may be a dual-light-emitting material which includes a porous framework containing a metal ion and an organic ligand, an insert body placed in a cavity of the porous framework, and a nanocrystal containing the metal ion of the porous framework. Herein, the organic ligand may be configured to emit room-temperature organic phosphorescence (RT-OP), and the nanocrystals may be configured to emit fluorescence.

According to an exemplary embodiment of the present disclosure, the organic ligand may be configured to emit phosphorescence through Dexter energy transfer with the insert body.

According to an exemplary embodiment of the present disclosure, the organic ligand may be a trimesic acid (TMA), the insert body may be a cyanuric acid (CA), and the dual-light-emitting material may emit phosphorescence in a solid state.

The metal ion may be Pb²⁺ according to an exemplary embodiment of the present disclosure.

The nanocrystal may be a perovskite nanocrystal according to an exemplary embodiment of the present disclosure.

The nanocrystal may be MAPbBr₃ according to an exemplary embodiment of the present disclosure.

According to another aspect of the present disclosure, a method of fabricating a dual light-emitting material may be provided, the method which includes a step of preparing a first solution in which the organic ligand and the insert body are dissolved (S100), a step of forming the porous framework containing the insert body by mixing a metal ion solution with the first solution (S200), and a step of forming a dual-light-emitting material by mixing a nanocrystal precursor solution with a suspension containing a porous framework containing the insert body (S300). Herein, the organic ligand may be configured to emit room-temperature organic phosphorescence (RT-OP), and the nanocrystals may be configured to emit fluorescence.

According to an exemplary embodiment of the present disclosure, the organic ligand may be configured to emit phosphorescence through Dexter energy transfer with the insert body.

According to an exemplary embodiment of the present disclosure, the organic ligand may be TMA, the insert body may be CA, and the dual-light-emitting material may emit phosphorescence in a solid state.

The metal ion may be Pb²⁺ according to an exemplary embodiment of the present disclosure.

The nanocrystal may be a perovskite nanocrystal according to an exemplary embodiment of the present disclosure.

The nanocrystal may be MAPbBr₃ according to an exemplary embodiment of the present disclosure.

Hereinafter, the present disclosure will be described in more detail with reference to experimental examples.

### [Materials]

Lead nitrate (Pb(NO₃)₂, 99.0%), TMA (95%), CA (98%), and other solvents, including, hexane (anhydride, 99.9%), benzene (anhydride, 99.9%), toluene (anhydride, 99.9%), chlorobenzene (anhydride, 99.9%), chloroform (anhydride, 99.9%), diethyl ether (anhydride, 99.9%), methanol (anhydride, 99.9%), ethanol (anhydride, 99.9%), isopropanol (anhydride, 99.9%), DMF (anhydride, 99.9%), and DMSO (anhydride, 99.9%) were purchased from Sigma-Aldrich and used in a stocking state. CH₃NH₃Br (MABr) was purchased from Xi'an Co.

### [Preparation of the Pb-MOF and Ph MOFs]

The Pb-MOF was synthesized through a conventional solvothermal reaction between Pb and TMA. A solution of TMA (0.6962 g) in 320 mL of deionized water was stirred at 63° C. for 1 hour to form a clear solution. Then, a clear solution of Pb (NO₃)₂·6H₂O (4.1802 g) in 30 mL of water was added to the ligand solution and the mixture was stirred vigorously at 63° C. for 1 hour. A white precipitate was formed, which was then washed twice using deionized water and collected through centrifugation. These purification steps were repeated three times. The obtained white product was dried at 70° C. for 12 hours under vacuum. In addition, Ph MOFs (x:1) were synthesized in the same manner using a TMA/CA ligand solution, wherein the CA molar concentration was x times higher compared to the TMA concentration.

### [Synthesis of MAPbBr₃ Nanocrystals on Pb-MOFs and pH MOFs]

MAPbBr₃ nanocrystals were synthesized by adding 500 μL of an MABr/methanol solution (1.0 mg/mL) to a suspension of the Pb-MOF or Ph MOFs (200 mg) in 10 mL of hexane. The MAPbBr₃ nanocrystals templated MOFs were rinsed using 20 ml of hexane and n-butanol and collected through centrifugation. These purification steps were repeated three times. To prevent thermal degradation of the perovskite nanocrystals, the precipitates were dried at room temperature for 12 hours under vacuum.

### [Experimental Results]

### Synthesis and Characteristics of the Ph MOFs

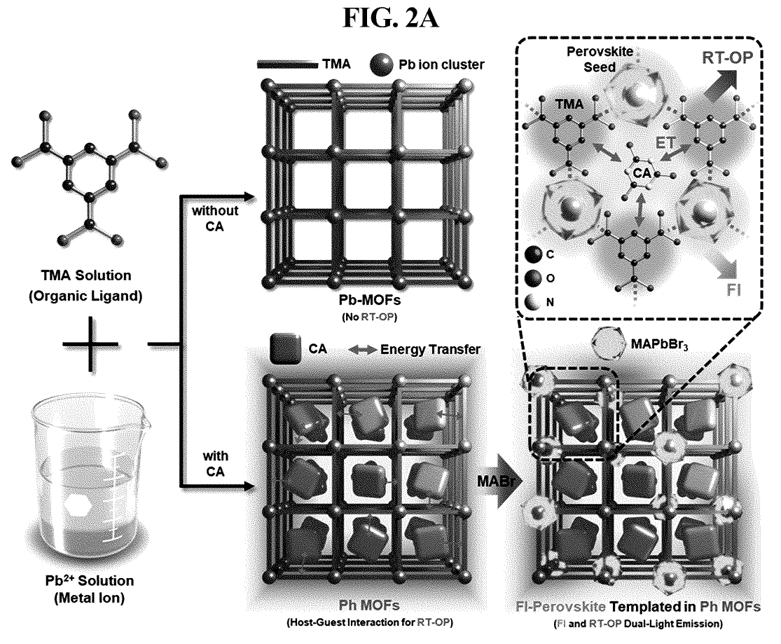

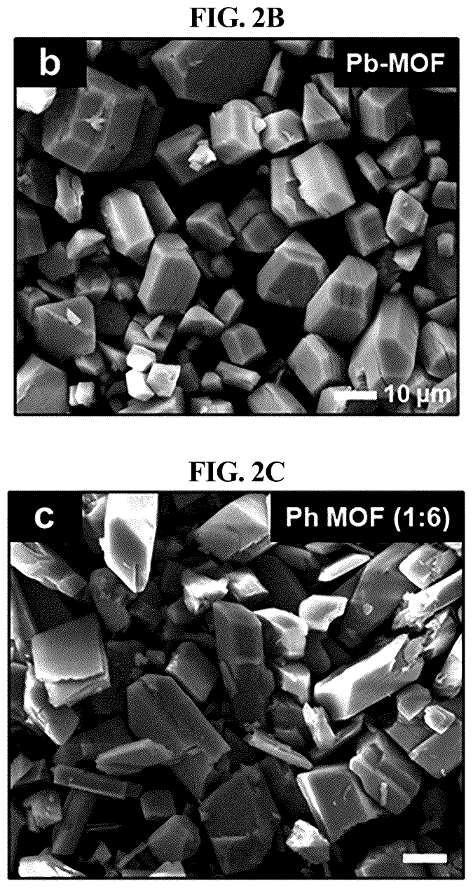

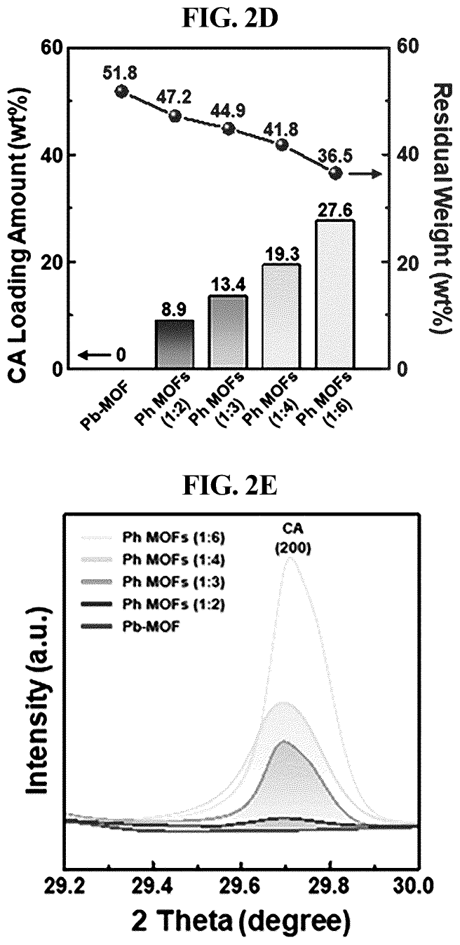

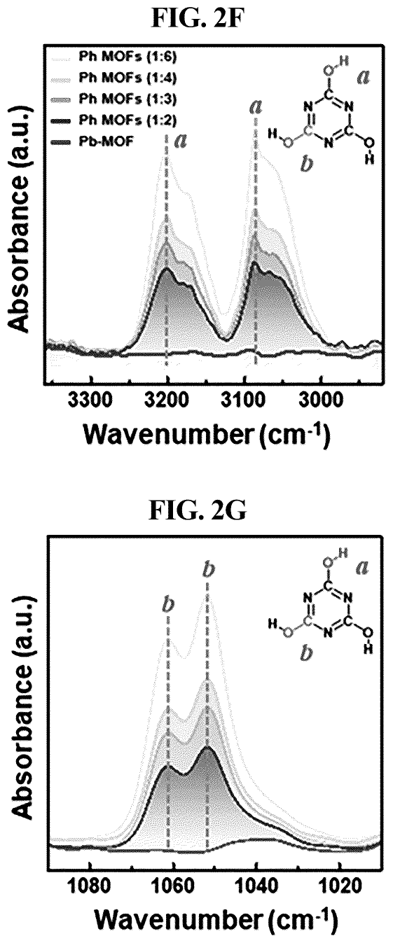

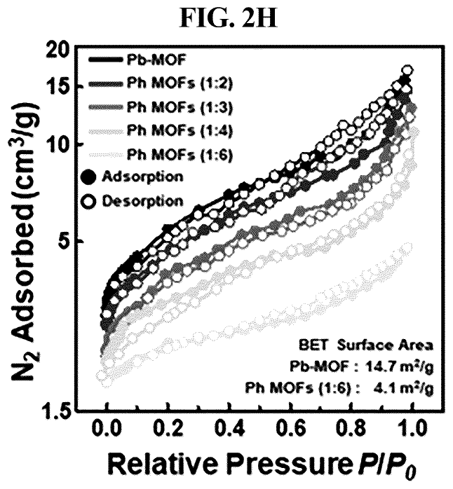

FIGS. 2A to 2H are views showing the synthesis and characteristics of MOF particles according to an exemplary embodiment of the present disclosure and specifically, as follows: FIG. 2A is a view showing a schematic diagram of the synthesis process for Pb-MOF, Ph MOF, and Fl-Ph MOF samples; FIG. 2B is a view showing an SEM image of a Pb-MOF; FIG. 2C is a view showing an SEM image of a Ph MOF (1:6); FIG. 2D is a view showing the actual CA loading amount (percentage) of the Ph MOF based on thermogravimetric analysis; FIG. 2E is a view showing the normalized XRD peak in the plane of CA (200) for Ph MOF having a CA loading amount different from that of Pb-MOF; FIG. 2F is a view showing O—H bond stretching vibrational peaks obtained from FTIR spectra of CA, Pb-MOF, and Ph MOF with different CA loading amounts; FIG. 2G is a view showing C—O bond stretching vibrational peaks obtained from FTIR spectra of CA, Pb-MOF, and Ph MOF with different CA loading amounts; FIG. 2H is a view showing an N₂ adsorption/desorption isotherm of Pb-MOF and Ph MOF with different CA loading amounts at 77 K.

In an exemplary embodiment of the present disclosure, a Pb-based MOF (Pb-MOF) containing coordinated Pb²⁺ metal centers bridged via a TMA organic linker was used. The Pb²⁺ center in the Pb-MOF was used as a Pb ion source for synthesizing fluorescent perovskite nanocrystals. In addition, RT-OP resulting from Dexter energy transfer between the rigidified CA and TMA in a framework was realized by introducing CA molecules into the cavities of the Pb-MOF as shown in FIG. 2A. Herein, CA was added during the Pb-MOF synthesis to deposit CA molecules in the pores of the Pb-MOF. Since the MOFs can fixate CA molecules with a constant molecular distance from the TMA molecules, the MOFs may allow Dexter energy transfer between the two species (CA (donor) and TMA (acceptor)) and bring RT-OP without an additional rigidification agent such as water. In addition, perovskite nanocrystals were subsequently synthesized by reacting the CA-containing Pb-MOF with the MAPbBr₃ precursor (i.e., MABr in methanol). The resulting product, that is, CA-containing Pb-MOFs with MAPbBr₃ nanocrystals may emit characteristic fluorescence and phosphorescence, which are attributed to perovskite nanocrystals and host-guest energy transfer respectively as shown in FIG. 2A. In the present application, the phosphorescent CA-containing Pb-MOFs may be referred to as Ph MOFs.

The properties of the CA-containing Pb-MOFs (Ph MOFs) having different CA loading amounts were first investigated before the synthesis of MAPbBr₃ in Ph MOFs. To this end, four types of Ph MOFs with initial CA loading amounts of 200, 300, 400, and 600% with respect to the TMA content (which can be referred to as Ph MOF (1:2), (1:3), (1:4), and (1:6), respectively) were synthesized via the conventional solvothermal reaction of TMA, CA, and Pb in water at 63° C. for 1 hour and the resulting product was subsequently washed three times using deionized (DI) water. The white precipitates obtained after centrifugation were dried in a vacuum oven at 70° C. The detailed synthetic procedures and precursor compositions of the CA-containing Pb-MOFs may be referred to the above-mentioned section. As shown in the scanning electron microscopy (SEM) images in FIGS. 2B and 2C, all the synthesized Ph MOFs having different CA contents were composed of triclinic crystals with an average longitudinal dimension of approximately 20 μm. From these results, it may be seen that the incorporation of CA in the Pb-MOFs hardly altered the morphologies of the final materials compared to that of the pristine Pb-MOF.

The amount of CA loaded into the Pb-MOF was estimated through thermogravimetric analysis under air. As shown in FIG. 2D, the CA loading amount increased with an increase in the CA concentration used in the synthesis process. Referring to FIG. 2D, the normalized residual weights of the samples decreased with an increase in CA content, which is attributed to the increase in the organic moieties of TMA and CA in a given sample having a constant initial weight. As shown in FIG. 2D, the weight percentages of CA in the Ph MOF (1:2), (1:3), (1:4), and (1:6) samples were determined to be approximately 8.9, 13.4, 19.3, and 27.6, respectively on the basis of the obtained results. Referring to FIG. 2E, it may be seen that the characteristic diffraction peak at (200), which is attributed to the triclinic Ph MOF crystals, was enhanced as the CA content in the Pb-MOF increased through a powder X-ray diffraction (XRD) analysis of the Ph MOF series. Referring to FIG. 2F and FIG. 2G, it may be seen that the strong characteristic peaks of CA at 3087 and 1052 cm−1, corresponding to O—H and C—O, respectively, increased in intensity with the increase of CA content in the Fourier-transform infrared spectroscopy (FTIR) spectra of the Ph MOFs, indicating that the CA content in the Pb-MOF may be systematically controlled. The N₂ adsorption/desorption isotherms of the Pb-MOF and the Ph MOF samples with different CA loading amounts are shown in FIG. 2H. The surface area of the pristine Pb-MOF (approximately 14.7 m²g⁻¹) decreased with the incorporation of CA. The surface areas were approximately 13.8, 11.0, 9.4, and 4.1 m²g⁻¹ for the Pb-MOF (1:2), (1:3), (1:4), and (1:6) samples, respectively. These results may clearly indicate that the cavities in the pristine Pb-MOFs were efficiently occupied by the CA molecules.

### Photophysical Properties of the Ph MOFs

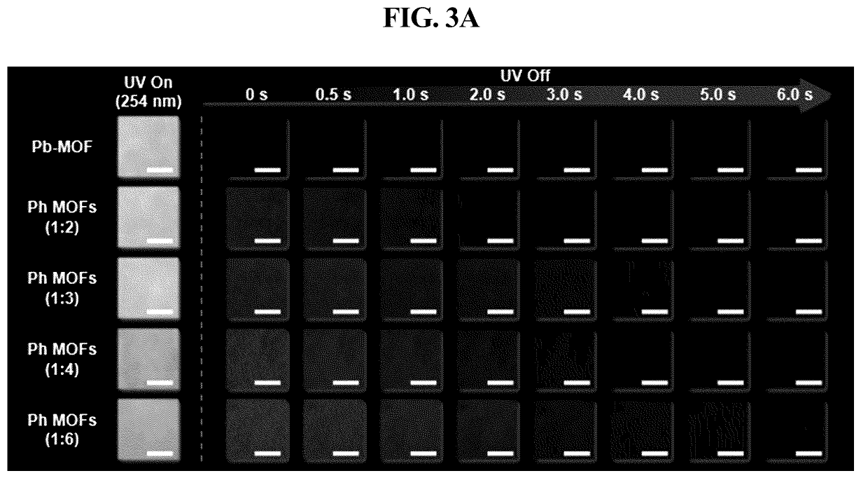

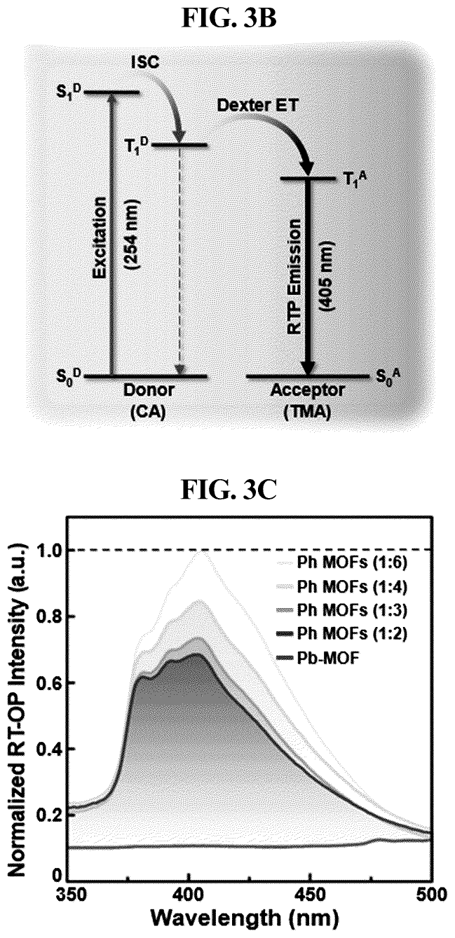

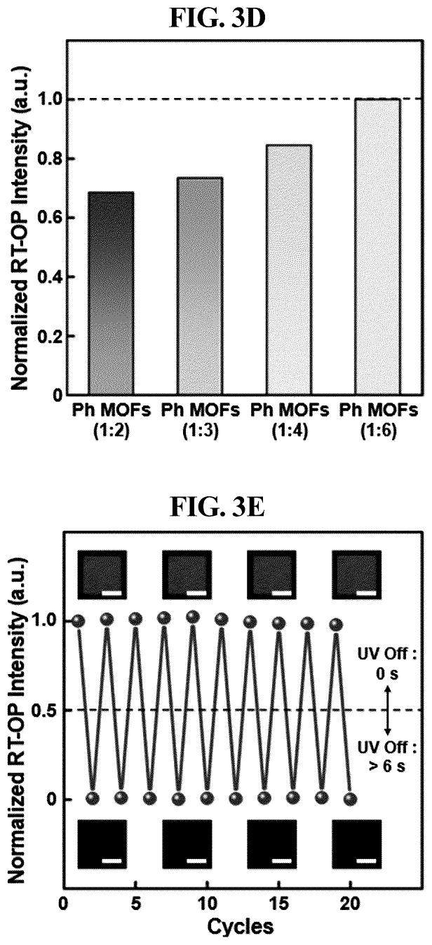

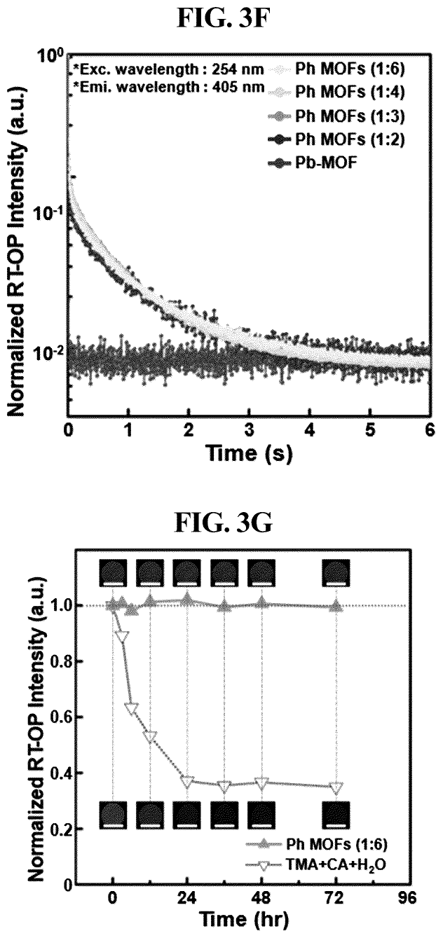

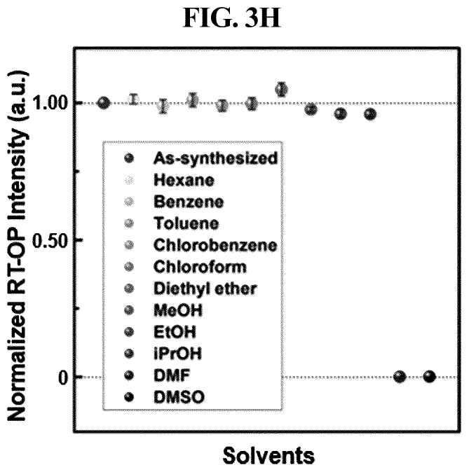

FIGS. 3A to 3H are views showing the photophysical properties of Ph MOF at room temperature according to an exemplary embodiment of the present disclosure, specifically as follows: FIG. 3A is a view showing a photograph of Pb-MOF, and Ph MOFs with different CA loading amounts, under Uv light irradiation (254 nm) and after different intervals after turning off the Uv lamp (scale bar: 1 cm); FIG. 3B is a view showing an energy-transfer mechanism for deep-blue (405 nm) phosphorescence of Ph MOF at room temperature; FIG. 3C is a view showing a steady-state RT-OP spectra for Pb-MOF and Ph MOFs with different CA loading amounts; FIG. 3D is a view showing a normalized intensity of the 405 nm emission for Pb-MOF, and Ph MOFs with different CA loading amounts; FIG. 3E is a view showing an RT-OP on/off switching cycle test (scale bar: 5 mm) using a Ph MOF (1:6) sample; FIG. 3F is a view showing a time-resolved phosphorescence decay curve of Pb-MOF and Ph MOFs with different CA loading amounts; FIG. 3G is a view showing a phosphorescence intensity (scale bar: 1 mm) of a Ph MOF (1:6) sample and a TMA/CA/H₂O mixture exposed to an atmosphere with 10% RH over time; FIG. 3H is a view showing a stability of a phosphorescence intensity of Ph MOF (1:6) sample in a variety of solvents.

Referring to FIG. 3A, the moderate deep-blue RT-OP emission of each Ph MOF powder sample may be clearly observed for more than 3-4 seconds after the UV (wavelength: 254 nm) lamp was turned off, while the bare Pb-MOF did not show afterglow.

From a series of photographs of four Ph MOF samples having different CA contents, it may be seen that the intensity of RT-OP emission increases with the CA content in the MOF, probably due to the increased Dexter energy transfer from CA to TMA, as schematically shown in FIG. 3B.

Through the PL spectra of the Ph MOF series of FIG. 3C, consistent with visual observation, it may be seen that the RT-OP intensity at the wavelength of 405 nm increased with the CA content. From these results, it may be seen that the energy transfer between CA and TMA species is successful and that the distance between CA and TMA units in a molecular framework is sufficiently short without an additional rigidification agent.

Through the normalized RT-OP intensity of the sample shown in FIG. 3D, it may be seen that the Ph MOF (1:6) had the highest RT-OP intensity. In addition, the absolute phosphorescence quantum yield of the Ph MOF (1:6) is approximately 49.4% in air at room temperature. However, an additional increase in the CA content in the Ph MOF resulted in the precipitation of the excess CA due to the limited solubility of CA. No improvement in phosphorescence properties was observed.

Remarkably, the phosphorescence of the Ph MOF (1:6) was stable and reliable. Referring to FIG. 3E, the degradation in the RT-OP of the Ph MOF (1:6) sample was barely observed even after exceeding 20 UV on/off cycles.

Referring to FIG. 3F, it may be seen that the average lifetime (τₐᵥₑ) of the Ph MOF powders having different CA contents were similar at approximately 0.52 seconds through the characteristic phosphorescence decay behaviors of the four Ph MOF samples.

The RT-OP stability of the Ph MOF (1:6) was investigated under continuous UV exposure, and the corresponding results are presented in FIG. 3G. According to the conventional works, the phosphorescence arising from the Dexter energy transfer between CA and TMA was triggered through water-driven hydrogen bonding between the hydroxyl groups of CA and the carboxyl groups of TMA, and the phosphorescence degraded with water evaporation. To exclude the possible contribution of water in Ph MOF (1:6), the stability of the RT-OP was investigated under a low relative humidity (RH) of approximately 10%. For comparison, a mixture of TMA and CA with water was prepared. As shown in FIG. 3G, the Ph MOF (1:6) sample maintained the initial RT-OP intensity over 3 days after being exposed to an atmosphere having 10% RH, whereas the RT-OP intensity of the TMA/CA/H₂O mixture decreased rapidly as water evaporated over time. These results may confirm the present inventor's speculation that the efficient RT-OP emission of the Ph MOF may be attributed to the uniform and rigid framework which keeps CA close to TMA without water.

Referring to FIG. 3H, the solvent stability of the Pb-MOF (1:6) sample was investigated by observing the RT-OP when immersed in a variety of solvents according to an exemplary embodiment of the present disclosure. The Ph MOF (1:6) sample remained unchanged and the initial RT-OP intensity was maintained over time when immersed in hexane, benzene, toluene, chlorobenzene, chloroform, diethyl ether, methanol, ethanol, and isopropanol, which are poor solvents for CA. However, the RT-OP of the Ph MOF (1:6) sample was lost after being immersed in good solvents for CA, including dimethylformamide (DMF) and dimethyl sulfoxide (DMSO), resulting in that CA was physically separated from TMA and emitted from the Pb-MOF, causing a loss of the RT-OP emission of the sample. The effect of the solvent may be identified on the basis of the changes in the XRD pattern as well.

Fl-Ph MOFs with Perovskite Nanocrystals

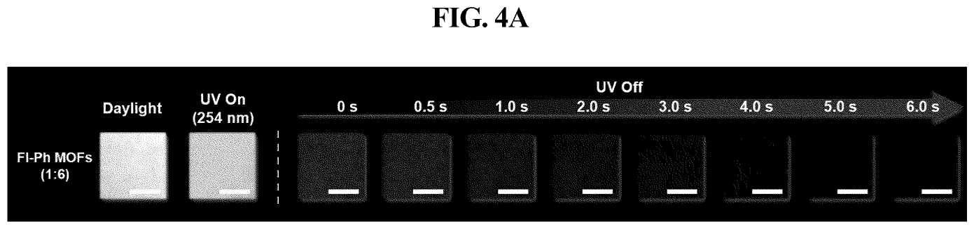

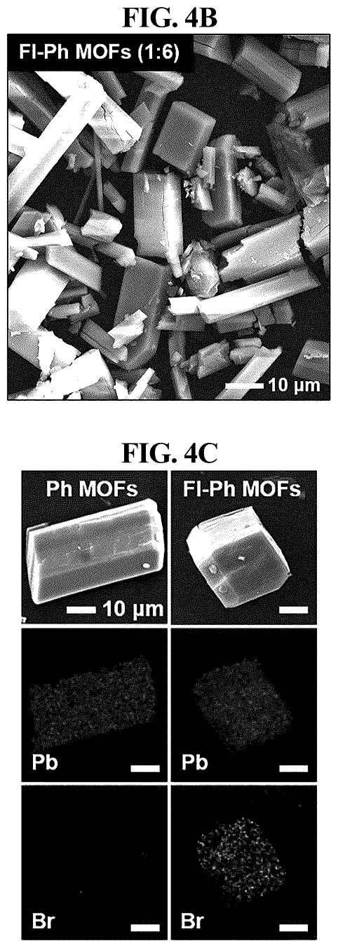

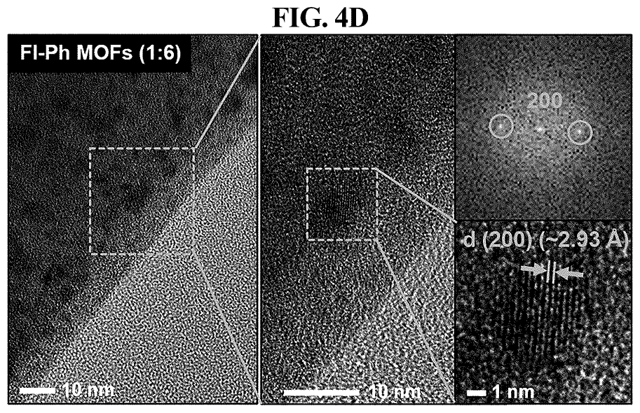

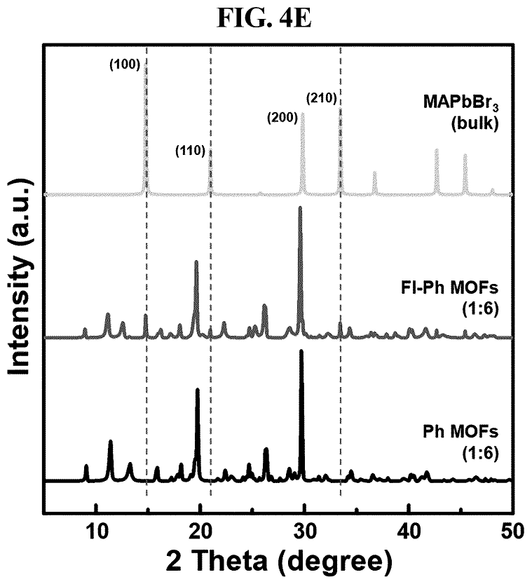

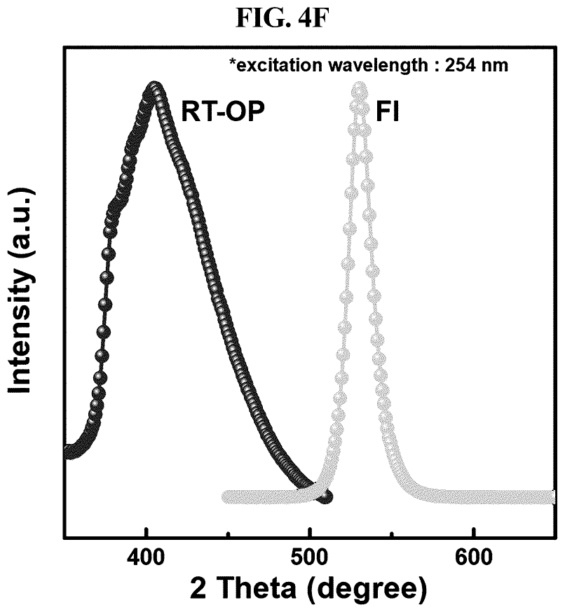

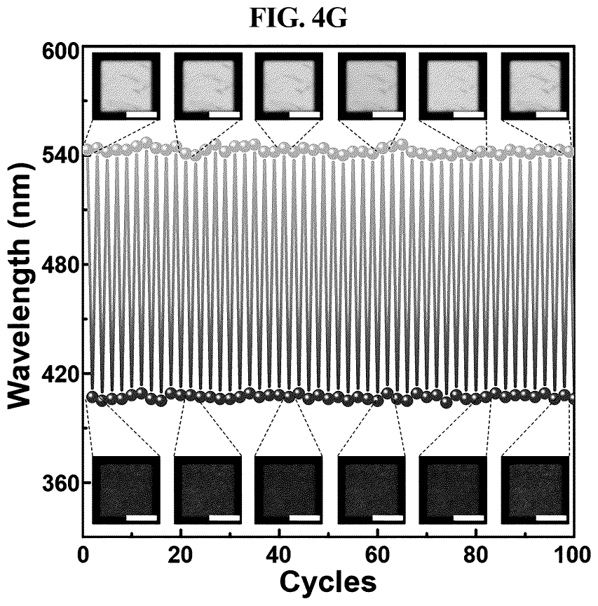

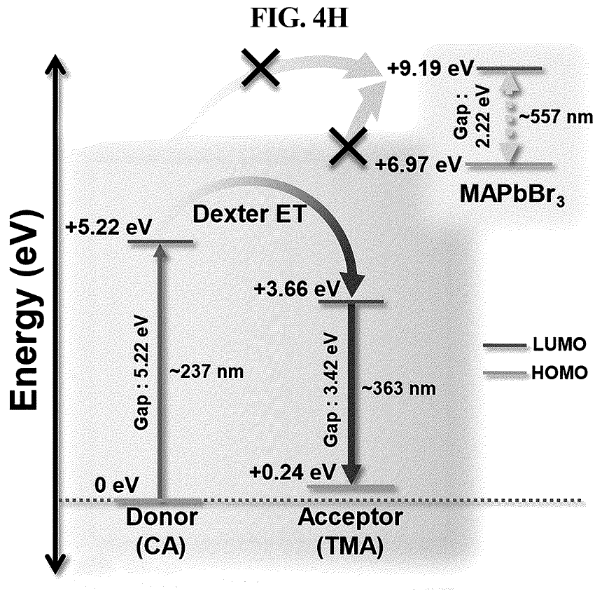

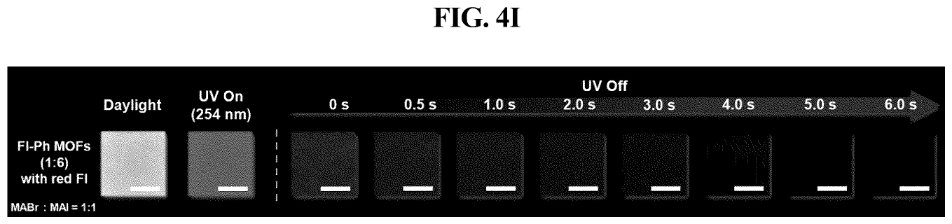

FIGS. 4A to 4I are views showing the characteristics of MAPbBr₃ and MAPbBrₓI₃₋ₓ perovskite NC-embedded Fl-Ph MOFs according to an exemplary embodiment of the present disclosure, more particularly as follows: FIG. 4A is a view showing a photograph (scale bar: 1 cm) of the Fl-Ph MOFs under daylight, under UV light (254 nm), and after turning off the UV lamp; FIG. 4B is a view showing an SEM image of Fl-Ph MOFs; FIG. 4C is a view showing an SEM-EDX elemental mapping image (Pb and Br mapping) of Ph MOF and Fl-Ph MOF; FIG. 4D is a view showing an HR-TEM image of the Fl-Ph MOF and an FFT pattern from the HR-TEM image; FIG. 4E is a view showing an XRD pattern of the Ph MOFs, MAPbBr₃(bulk), and Fl-Ph MOFs; FIG. 4F is a view showing a PL spectra of the Fl-Ph MOF under 254 nm excitation; FIG. 4G is a view showing a reversible PL and RT-OP switching test (scale bar: 5 mm) using Fl-Ph MOFs; FIG. 4H is a view showing the proposed mechanism of dual luminescence of Fl-Ph MOFs using relative frontier orbital energy; FIG. 4I is a view showing a photograph of a red fluorescent Fl-Ph MOF using an iodine-containing perovskite (MAPbBrₓI₃₋ₓ) NC under daylight, under UV light (254 nm), and after turning off the UV lamp.

The synthesized Pb-MOF having Pb ions in the molecular framework enabled a convenient MOF-template synthesis of Pb-based fluorescent perovskite nanocrystals, i.e., MAPbBr₃ nanocrystals. Fluorescent MAPbBr₃ nanocrystals were synthesized using the Ph MOF (1:6) template in order to develop a novel dual-light-emitting MOF having both fluorescence and phosphorescence emissions according to an exemplary embodiment of the present disclosure. MAPbBr₃ nanocrystals were fabricated in the Ph MOF (1:6) by adding a MABr/methanol solution to a suspension containing the Ph MOF of in hexane, and by vigorously, stirring washing, and drying at room temperature. The detailed MAPbBr₃ synthesis procedure may be referred to the part described above. Referring to FIG. 4A, a perovskite nanocrystal-embedded MOFs may be referred to as Fl-Ph MOF because exhibiting both fluorescence and phosphorescence.

As shown in FIG. 4B, The Fl-Ph MOF (1:6) samples were successfully produced as a characteristic triclinic powder, and its dimensions were similar to those of the Pb-MOF and Ph MOF samples.

Referring to FIG. 4C, the presence of MAPbBr₃ nanocrystals in Fl-Ph MOF powders was additionally identified through SWM-energy dispersive X-ray (EDX) Br mapping.

Referring to FIG. 4D, furthermore, the HR-TEM image may show that the MAPbBr₃ nanocrystals are embedded inside the Fl-Ph MOF. As shown FIG. 4D, an interplanar distance of approximately 2.92 Å, corresponding to the (200) crystal faces of the cubic MAPbBr₃, was clearly identified from the fast Fourier transform (FFT) image. The characteristic X-ray energy corresponding to the Br atoms was observed in the EDX profile of the Fl-Ph MOF, whereas the same signal was barely detected for the Ph MOF.

Referring to FIG. 4E, the crystal structure of the perovskite nanocrystals grown on the Ph MOF template was investigated through XRD, and the pattern in FIG. 4E may clearly present three new and distinct peaks at 14.9°, 21.2°, and 33.7°, corresponding to the (100), (110), and (210) planes of cubic MAPbBr₃ (space group: Pm3m; No. 211).

As shown in a series of photographs of FIG. 4A, the characteristic deep-blue RT-OP emission of the Fl-Ph MOF was also visualized as an afterglow after the UV lamp was turned off. As shown in FIG. 4A, the transient blue RT-OP was concealed by the green fluorescence during UV exposure due to the large difference in intensity between the fluorescence and RT-OP emission. Referring to FIG. 4F, The Fl-Ph MOF emitted green fluorescence having an emission maximum of 530 nm and a quantum yield of 31.44% under 365 nm excitation. As shown in FIG. 4G, the dual light emission of the Fl-Ph MOF under UV exposure was stable after repetitive switching on/off cycles of the UV lamp in excess of 100 cycles. The Fl-Ph MOF also maintained the initial Fl and RT-OP intensities over 3 days after being exposed to an atmosphere with 10% RH. In addition, bulk MAPbBr₃ perovskite powder was synthesized under the same conditions for comparison. The initial fluorescence intensity dropped rapidly when exposed to an atmosphere having a relative humidity of 10% due to the poor stability of pure MAPbBr₃ crystal powder in the air. After 12 hours of exposure, only 10% of the initial intensity was maintained. The superior air stability of Fl-Ph MOFs was attributed to the protective effect of the MOF matrix. When the UV lamp was turned off, the fluorescence at a wavelength of 530 nm disappeared immediately, while the RT-OP was clearly visible at a wavelength of 405 nm. After a few seconds, the RT-OP emission decreased in intensity.

First-principles density functional theory (DFT) calculations were used to explain the mechanism underlying the dual light emission of the Fl-Ph MOF. To this end, first, the three main optoelectronic components of the Fl-Ph MOF, namely CA, TMA, and MAPbBr₃, were modeled using separate non-interacting models. As shown FIG. 4H, it was found by using the relative frontier orbital energy level that the conduction band minimum (CBM) and valence band maximum of MAPbBr₃ were significantly elevated compared to the lowest unoccupied molecular orbital level of CA and TMA. Through the significant elevation of the CBM of MAPbBr₃, it may be seen that Dexter energy transfer is not feasible between the perovskite nanocrystals and donor/acceptor materials. In addition, an electronic transition facilitated to be possible between the donor/acceptor and perovskite due to the close proximity between the different components was investigated. As a result of investigations, it turned out that the addition of TMA resulted in the generation of a mid-gap state with a lower energy level compared to the perovskite conduction state. These results show that spontaneous electronic transition is not possible between TMA with lower energy levels and the perovskite CBM with higher energy levels even when TMA and perovskite are in close proximity. In contrast, CA has an electronic state that overlaps with that of MAPbBr₃ above the Fermi level. However, electronic transitions between these two materials are hardly feasible due to the spatial separation between the CA and MAPbBr₃ clusters in the MOF. In addition, referring to FIG. 4I, a Fl-Ph MOF with the independent red fluorescence and blue phosphorescence emission based on MAPbBrₓI₃₋ₓ nanocrystals was developed by adding a certain amount of methylammonium iodide (MAI) to the perovskite precursor solution.

In a two-dimensional security method using a fluorescent-phosphorescent dual-light-emitting material according to another aspect of the present disclosure, the method ma include an encryption process composed of attaching a masking tape to a substrate, exposing an area for encryption information to be printed by patterning the masking tape, printing on the exposed area the encryption information where real information is combined with fake information by printing real information in the ink mixed by the fluorescent-phosphorescent dual-light-emitting material as well as by printing fake information associated with real information in the ink mixed with a fluorescent material, and removing the masking tape, and a decryption process composed of emitting fluorescence by radiating ultraviolet rays to the encryption information for a predetermined time, and displaying real information through phosphorescence of real information when luminescence of fake information stops after irradiation of the ultraviolet rays stops.

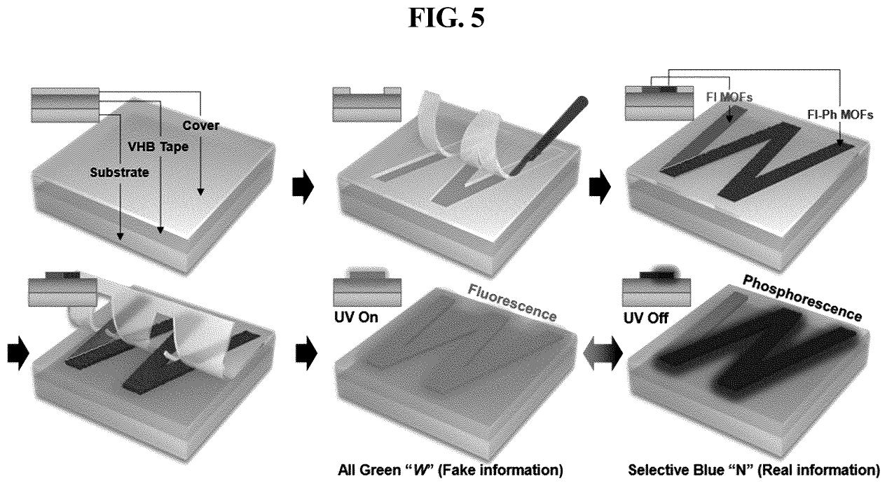

Hereinafter, a two-dimensional security method using a fluorescent-phosphorescent dual-light-emitting material will be described with reference to FIG. 5 according to a preferred exemplary embodiment of the present disclosure.

FIG. 5 is a view showing a flowchart of an encryption process and a decryption process of a two-dimensional security method using a fluorescent-phosphorescent dual-light-emitting material according to a preferred exemplary embodiment of the present disclosure, wherein a cross-sectional structure is shown with a three-dimensional structure in each step for ease of understanding. In a preferred exemplary embodiment of the present disclosure, an encryption ink composed of a polymer solution containing a fluorescent-phosphorescent dual-light-emitting material and a camouflage ink composed of a polymer solution containing only a fluorescent material may be directly printed on the surface of the VHB tape (3M) using an art technique called pochoir.

First, a masking tape may be attached to the top of the surface to be printed. For example, a masking cover may be attached to the surface of a substrate using a high adhesive double-sided tape such as very high bonding (VHB) manufactured by 3M as shown in FIGS. 2A to 2H.

Thereafter, the masking cover may be patterned to expose an area in which encryption information is to be printed.

In the exposed area, real information may be printed in the encryption ink including a fluorescent-phosphorescent metal-organic framework (Fl-Ph MOF) containing a fluorescent-phosphorescent dual-light-emitting material and fake information associated with real information may be printed in the camouflage ink including a fluorescent metal-organic framework (Fl-MOF) containing only fluorescent materials, thereby printing encryption information that is a combination of real information and fake information.

In FIG. 5, the real information “N” may be printed using the encryption ink composed of a polymer solution (Fl-Ph MOF) containing a fluorescent-phosphorescent dual-light-emitting material, and the fake information, a stroke that makes “N” associated with the real information “N” appear as “W” may be printed using a polymeric camouflage ink (Fl-MOF) mixed with only fluorescent materials, thereby printing an encryption information “W” that makes it impossible to identify the real information “N”.

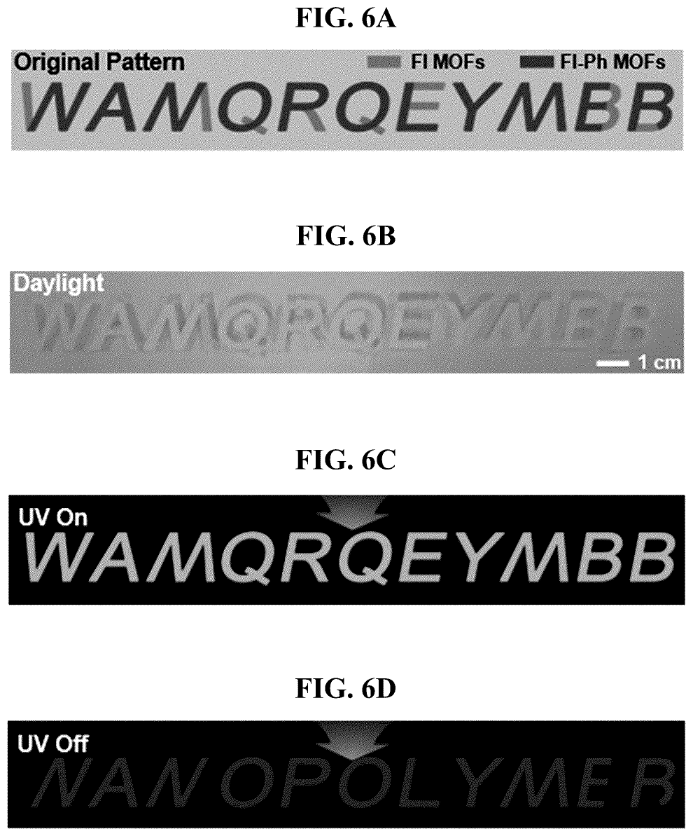

Hereinafter, an example where the above-described principle is practically applied will be described with reference to FIGS. 6A to 6D. FIGS. 6A to 6D are exemplary diagrams for explaining a principle of encryption and a principle of decryption according to a two-dimensional security method using a dual-light-emitting material according to a preferred exemplary embodiment of the present disclosure.

Referring to FIG. 6A, the encryption information, “WAMQRQEYMBB”, may be generated by adding fake information to “NANOPOLYMER”, which is real information called a nano polymer. That is, the part of the “NANOPOLYMER”, which is real information, may be printed with the encryption ink including a fluorescent-phosphorescent metal-organic framework (Fl-Ph MOF), and a remaining fake information part of “WAMQRQEYMBB”, which excludes the real information, may be printed with the camouflage ink including a fluorescent metal-organic framework (Fl-MOF).

According to an aspect of the present disclosure, provided may be a dual-light-emitting material which includes a porous framework containing a metal ion and an organic ligand, an insert body placed in a cavity of the porous framework, and a nanocrystal containing a metal ion of the porous framework. Herein, the organic ligand may be configured to emit room-temperature organic phosphorescence (RT-OP), and the nanocrystals may be configured to emit fluorescence.

As a result, encryption information in which fake information and real information are mixed may be printed as shown in FIG. 6A.

Although the description is made with meaningless character combinations for convenience in the present exemplary embodiment, encryption information may be formed by combining fake information with a combination of meaningful characters in order to lure potential plagiaristic users other than the user to other information in another exemplary embodiment.

Again, the decrypting process will be described back to FIG. 5.

The encryption information printed according to the two-dimensional security method using a duel-light-emitting material according to a preferred exemplary embodiment of the present disclosure may appear to be bright green fluorescence over the entire “W”, which is encryption information mixed with fake information and real information when irradiated with ultraviolet rays (UV on) as shown in FIG. 5.

Afterwards, the real information “N” printed with the encryption ink containing the fluorescent-phosphorescent metal-organic framework (Fl-Ph MOF) may be displayed with blue phosphorescence while the fake information printed with camouflage ink containing fluorescent metal-organic frameworks (Fl MOFs) immediately disappear when irradiation of the ultraviolet rays stops (UV Off).

As shown in FIG. 6B, encryption information “WAMQRQEYMBB” printed with two types of ink, encryption ink and camouflage ink, may be almost invisible when written on a white substrate under daylight (Daylight).

On the other hand, as shown in FIG. 6C, when UV light irradiates encryption information (UV On), the character may become clear with bright green fluorescence. In this case, the encrypted pochoir character pattern “WAMQRQEYMBB” may be visible instead of the real information “NANOPOLYMER”.

Afterwards, the real information in the form of “NANOPOLYMER” may be clearly seen as a blue room-temperature organic phosphorescence (RT-OP) emitted from the area printed with encryption ink containing a fluorescent-phosphorescent metal-organic framework (Fl-Ph MOF) when the UV light is turned off (UV Off) as shown in FIG. 6D.

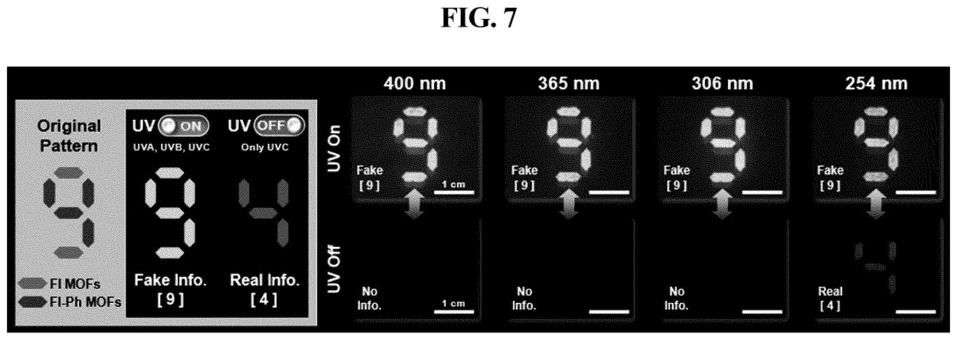

Meanwhile, only the encryption information may be visible with characteristic green fluorescence when the encryption information is exposed to UV light of higher wavelengths such as 254, 306, 365, 400 nm, and the real information may not appear even after the UV light is turned off as shown in FIG. 7, which shows an experimental result on the decryption results for each wavelength of ultraviolet rays applied to a two-dimensional security method using a dual-light-emitting material according to a preferred exemplary embodiment of the present disclosure. Therefore, it may be preferable to use a wavelength equal to or less than 254 nm for the UV lamp.

As described above, the decay behavior of fluorescence and fluorescence-phosphorescence luminescence, which have substantially different decay times of several nanoseconds and several seconds respectively, may be useful for information encryption according to the two-dimensional security method using a dual-light-emitting material according to a preferred exemplary embodiment of the present disclosure. That is, the two types of optical information generated on the basis of fluorescence and fluorescence-phosphorescence may independently be able to be read on different time scales.

Accordingly, real information that emits dual luminescence of fluorescence and phosphorescence may be concealed behind encryption information that emits entirely fluorescence, and moreover, there may be an effect of increasing security by luring to the encryption information that is different from the real information by the camouflage information according to the two-dimensional security method using a dual-light-emitting material according to a preferred exemplary embodiment of the present disclosure.

In a method of fabricating a dual-light-emitting encryption cube capable of dual luminescence of fluorescence and phosphorescence according to another aspect of the present disclosure, the method may include a step of mixing a fluorescent light-emitting material with a polymer solvent to form a fluorescent solution, mixing a fluorescent-phosphorescent dual-light-emitting material with a polymer solvent to form a fluorescent-phosphorescent solution, and respectively filling the fluorescent solution and the fluorescent-phosphorescent solution into an engraved pattern of a separately patterned mold, a step of drying the fluorescent solution and the fluorescent-phosphorescent solution filled in the mold at room temperature only to form fluorescent filaments and fluorescent-phosphorescent filaments respectively, and a step of cutting the fluorescent filament and the fluorescent-phosphorescent filament as much as a predetermined cube branch length of the encryption cube, wherein an information branch of the encryption cube included in the three-dimensional encryption pattern is assembled with the fluorescent-phosphorescent filaments and a camouflage branch of the encryption cube not included in the three-dimensional encryption pattern is assembled with the fluorescent filaments according to a predetermined three-dimensional encryption pattern.

Hereinafter, a method for fabricating a dual-light-emitting encryption cube will be described according to a preferred exemplary embodiment of the present disclosure.

In this exemplary embodiment, fabricated may be a fluorescent filament using a polymer composite material containing a fluorescent metal-organic framework (Fl MOF) in a polycaprolactone (PCL) solution and a fluorescent-phosphorescent filament using a polymer composite material containing a fluorescent-phosphorescent metal-organic framework (Fl-Ph MOF) in a PCL solution.

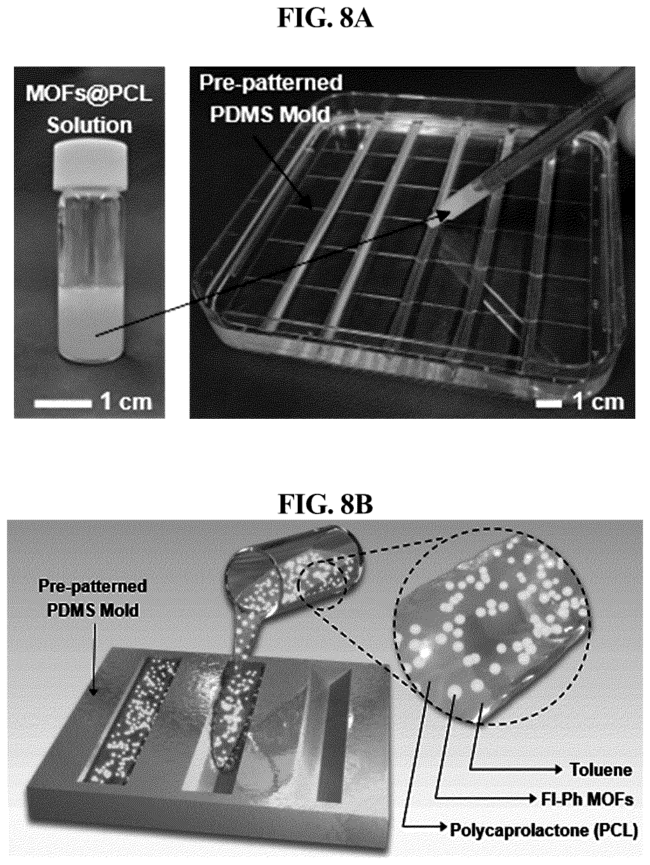

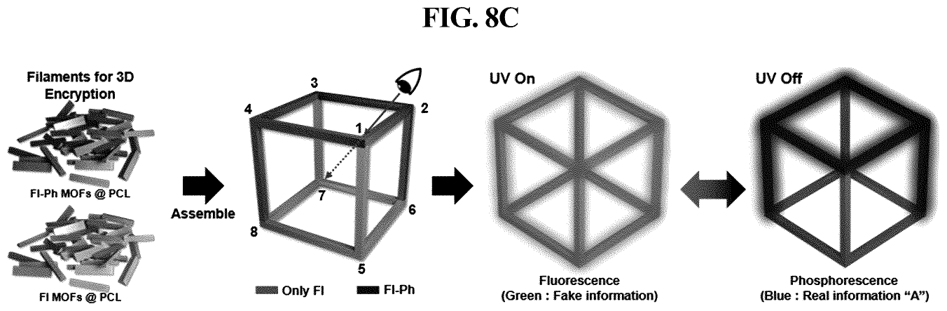

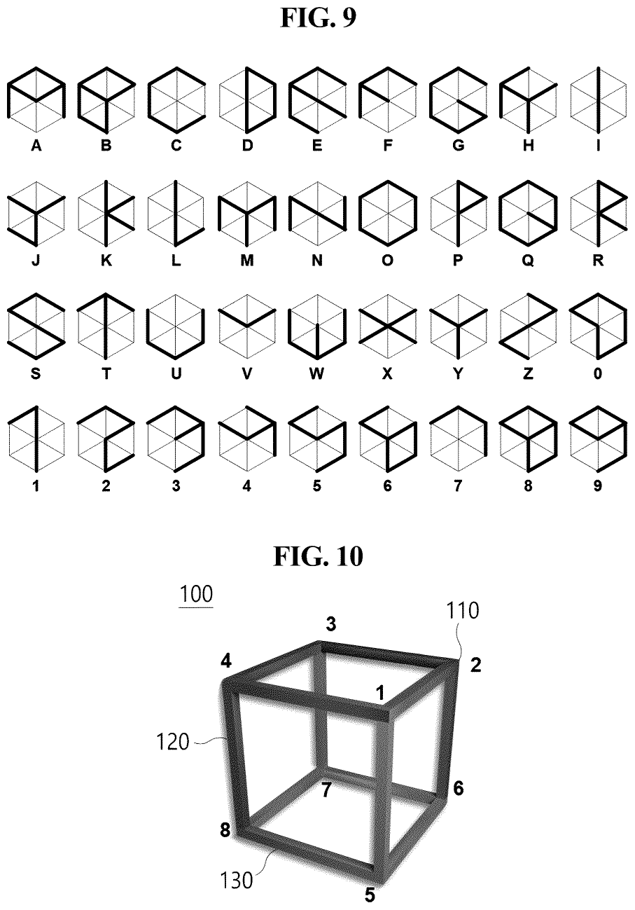

For example, MOF powder (0.096 g) and PCL polymer pulp (0.2 g) were dispersed in toluene (0.8 g) as shown in FIG. 8A. PCL was completely dissolved in toluene.

For example, a lead (Pb)-containing metal-organic framework (MOF) may be used as the fluorescent metal-organic framework (Fl MOF), but other fluorescent materials may be used.

Meanwhile, the fluorescent-phosphorescent metal-organic framework (Fl-Ph MOF) may be based on a lead (Pb)-containing metal-organic framework (MOF) having a trimesic acid (TMA) organic ligand in a preferred exemplary embodiment of the present disclosure. When a cyanuric acid (CA) molecule is included as a guest in the periodic cavity of the lead (Pb)-containing metal-organic framework (MOF), both trimesic acid (TMA) and cyanuric acid (CA) may be efficiently fixated at a suitable distance for Dexter energy transfer under ambient conditions, leading to stable deep-blue room-temperature organic phosphorescence (RT-OP). When a perovskite precursor, methylammonium bromide (MABr), was mixed with the lead (Pb)-containing metal-organic framework (MOF) combined with cyanuric acid (CA), fluorescent MAPbBr₃ nanocrystals exhibiting characteristic green luminescence under UV irradiation may generate the dual-light-emitting Fl-Ph in the MOF.

Polymer composite material including fluorescent metal-organic frameworks (Fl MOFs) and polymer composite material including fluorescent-phosphorescent metal-organic frameworks (Fl-Ph MOFs) prepared in this manner may be fabricated by filling in a pre-patterned polydimethylsiloxane (PDMS) mold and then vacuum dried at room temperature respectively as shown in FIG. 8B.

For example, pre-patterned polydimethylsiloxane (PDMS) molds may be fabricated by curing polydimethylsiloxane (PDMS) with a curing agent at a weight ratio of 10:1 for 12 hours in an oven at 60° C. and then patterned with engraved lines along the skeleton of the cube branch on a fully cured PDMS plate.

The engraved line pattern of the patterned PDMS mold in the way may be then poured with Fl MOF-containing solution or Fl-Ph-containing solution and vacuum dried at room temperature for 3 hours for toluene evaporation, and finally detached from the PDMS mold.

As a result, a plurality of fluorescence (Fl) cube branches and fluorescence-phosphorescence (Fl-Ph) cube branches may be formed as shown in FIG. 8C. The blue color is the fluorescence-phosphorescence (Fl-Ph) cube branches, and the red color is the fluorescence (Fl) cube branches.

These fluorescent-phosphorescent cube branches and fluorescent cube branches may be disposed at each corner of the cube according to a predetermined three-dimensional encryption pattern structure. For example, a fluorescent-phosphorescent (Fl-Ph) cube branch may be disposed on an information branch forming a real information pattern on the basis of a predetermined pattern of characters, numbers, symbols and the like as shown in FIG. 9, which shows a three-dimensional encryption pattern structure according to a preferred exemplary embodiment of the present disclosure, and a fluorescent (Fl) cube branch may be disposed on a camouflage branch forming the remaining camouflage pattern other than the real information, thereby assembling a dual-light-emitting encryption cube as shown in FIG. 10.

As a result, an encryption cube 100 composed of eight vertices 110 and twelve cube branches 120 and 130 may be fabricated.

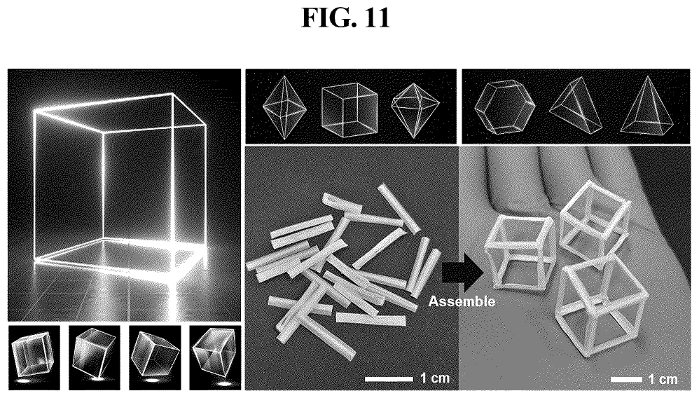

Although a method of fabricating a cubic encryption cube as an encryption cube has been described in the present disclosure, it may be fabricated in other forms of shapes as needed as shown in FIG. 11.

In addition, in order to facilitate the coupling of the cube branches, a vertex may further include a vertex branch coupler composed of a porous sphere that forms a plurality of closed holes to which the cube branches are connected in another exemplary embodiment of the present disclosure. That is, the vertex branch coupler may be composed of a porous sphere in which closed holes are formed in the sphere in three directions: a horizontal axis (x), a vertical axis (y), and a vertical axis (z) orthogonal to the plane formed by the horizontal and vertical axes, such that a cube branch may be selectively coupled to each closed hole. Thereby, the assembly of the encryption cube according to the present disclosure may be facilitated.

In addition, the vertex branch coupler may be marked by a vertex branch coupling identifier to facilitate the coupling of cube branches in another exemplary embodiment of the present disclosure. That is, by displaying the vertex branch coupling identifier on the vertex branch coupler in order to identify which vertex of the encryption cube the corresponding coupling hole is, it may be possible to accurately assemble the encryption cube when assembling the encryption cube and to accurately identify a vertex of the encryption cube when decrypting, thereby capable of setting the encryption cube to the correct position and angle.

According to another aspect of the present disclosure, a dual-light-emitting encryption cube having a three-dimensional encryption pattern by dual luminescence of fluorescence and phosphorescence includes eight vertices of a cube and twelve cube branches connecting eight vertices, wherein an information branch of the encryption cube included in the three-dimensional encryption pattern is made of fluorescent-phosphorescent filaments, and a camouflage branch of the encryption cube not included in the three-dimensional encryption pattern is made of fluorescent filaments according to the predetermined three-dimensional encryption pattern, wherein the information branch and the camouflage branch are disposed in any one of six external branches forming a cube centered on the vertices, and six internal branches connecting the vertices to each contact point of the six external branches.

As shown in FIG. 10, the dual-light-emitting encryption cube 100 according to a preferred exemplary embodiment of the present disclosure may be composed of eight vertices 110 and twelve cube branches 120 and 130.

For example, when taking the pattern set with the alphabet “A” in FIG. 9 as an example, six information branches, where 1-2 cube branch, 2-3 cube branch, 3-4 cube branch, 4-1 cube branch, 4-8 cube branch, and 2-6 cube branch form a real information pattern centering on the vertex “1”, may be formed with fluorescent-phosphorescent (Fl-Ph) cube branches.

Then, a total of six camouflage branches, where 3-7 cube branch, 1-5 cube branch, 5-6 cube branch, 6-7 cube branch, 7-8 cube branch, and 8-5 cube branch may form the remaining part of the cube other than real information with fluorescent (Fl) cube branches.

As a result, when viewed from a vertex “1”, a three-dimensional security pattern composed of six external branches forming a regular hexagon and six internal lines connecting a vertex to the contact point where each external branch meets may be formed centered on the vertex “1” 110 as shown in FIG. 8C.

Afterward, when UV light irradiates an encryption cube having a three-dimensional security pattern, all six external branches and six internal branches may emit green fluorescence as shown in FIG. 8C. Then, when irradiation of the ultraviolet rays stops, the camouflage branch formed by the fluorescent (Fl) cube branches may stop luminescence, and only the information branches formed by the fluorescent-phosphorescent (Fl-Ph) cube branches may emit blue phosphorescence, so that only the real information pattern is displayed in blue.

It may be seen that the real information is “A” according to the predetermined encryption pattern.

In addition, a vertex may include a vertex branch coupler composed of a porous sphere which forms a plurality of closed holes to which the cube branches are connected in another exemplary embodiment of the present disclosure. In this case, the vertex branch coupler may be composed of a porous sphere in which closed holes are formed in the sphere in three directions: a horizontal axis (x), a vertical axis (y), and a vertical axis (z) orthogonal to the plane formed by the horizontal and vertical axes, such that a cube branch may be selectively coupled to each closed hole.

In addition, the vertex branch coupling identifier may be displayed on the vertex branch coupler.

As a result, it may be possible to set the encryption cube to the correct position and angle according to a three-dimensional encryption pattern and to accurately read the position and angle of the encryption cube when decrypting the three-dimensional encryption pattern.

In a three-dimensional security method using a dual-light-emitting encryption cube that is three-dimensionally patterned with a fluorescent light-emitting material and a fluorescent-phosphorescent dual-light-emitting material according to another aspect of the present disclosure, the encryption cube may be generated as a patterned encryption cube by assembling the cube branch using fluorescent-phosphorescent dual-light-emitting material with respect to the information branch of the encryption cube forming the three-dimensional encryption pattern and by assembling the cube branch using fluorescent light-emitting material with respect to the camouflage branch of the encryption cube not included in the three-dimensional encryption pattern, and the three-dimensional security method includes a process of an encryption setting for setting a user's password according to a three-dimensional encryption pattern set between the user terminal and the security device, a process of inputting the user password at the user terminal that includes a step of arranging the information branches and the camouflage branches in the correct positions centered on the vertices according to each encryption pattern of the patterned encryption cubes while arranging sequentially the encryption cubes corresponding to the user password among the pre-patterned encryption cubes, a step of radiating ultraviolet rays to encryption cubes arranged sequentially according to the user password during a predetermined time, a step of photographing the encryption cubes arranged sequentially according to the encryption information after stopping the irradiation of the ultraviolet rays, a step of generating a password input information by binarizing the information branch and the camouflage branch of each photographed encryption cube, and a step of transmitting the generated password input information to the security device, and a process of decrypting the input user password in the security device, the process that includes a step of sequentially generating a three-dimensional encryption pattern of the encryption cube on the basis of the binary information of the user password transmitted from the user terminal, a step of calculating a matching rate by comparing the pattern of the user password registered in the encryption setting process with the generated three-dimensional encryption pattern of the encryption cube, and a step of releasing security and providing information as matching success when the matching rate is more than a predetermined value or transmitting a matching failure notification as matching failure when the matching rate is less than the predetermined value.

A three-dimensional security method using a dual-light-emitting cube may include an encryption process and a decryption process according to a preferred exemplary embodiment of the present disclosure.

First, referring to FIG. 8C, the encryption cube according to the present disclosure may be composed of a plurality of fluorescence (Fl) cube branches and fluorescence-phosphorescence (Fl-Ph) cube branches. The blue color is the fluorescence-phosphorescence (Fl-Ph) cube branches, and the red color is the fluorescence (Fl) cube branches.

A fluorescent-phosphorescent (Fl-Ph) cube branch may be disposed on an information branch forming a real information pattern on the basis of a predetermined pattern of characters, numbers, symbols and the like as shown in FIG. 9, and a fluorescent (Fl) cube branch may be disposed on a camouflage branch forming the remaining camouflage pattern other than real information, thereby assembling a dual-light-emitting encryption cube as shown in FIG. 10.

As a result, an encryption cube 100 composed of eight vertices 110 and twelve cube branches 120 and 130 may be fabricated.

For example, a user's password may be set according to a three-dimensional encryption pattern set between a user terminal such as a mobile phone and a security device. Hereinafter, a user terminal and mobile phone may be used interchangeably as synonyms.

In this exemplary embodiment, it may be taken as an example that “NP” is set as the user password using two encryption cubes. Encryption cubes may be designed from 1 digit to a variety of digits depending on the system design.

First, the user may register security in a system in order to use a variety of systems such as banks, securities, paid information companies, and the like. In this case, the user's password may be registered by receiving predetermined three-dimensional encryption pattern information from the security system as shown in FIG. 9. It may be more preferable in terms of security to prepare a plurality of patterns for such a three-dimensional encryption pattern and to provide different three-dimensional encryption pattern information for each user. Such encryption registration may be possible online or offline, and an encryption cube used in a security device may be provided from the security system. In this case, an encryption cube set may be provided, and two sets of encryption cubes may be provided: one in which a three-dimensional encryption pattern of “N” corresponding to the password “NP” encrypted by the user is registered, and the other in which a three-dimensional encryption pattern of “P” is registered. Naturally, the number of encryption cubes may vary depending on the number of passwords registered by the user, that is, the number of passwords registered in the security system.

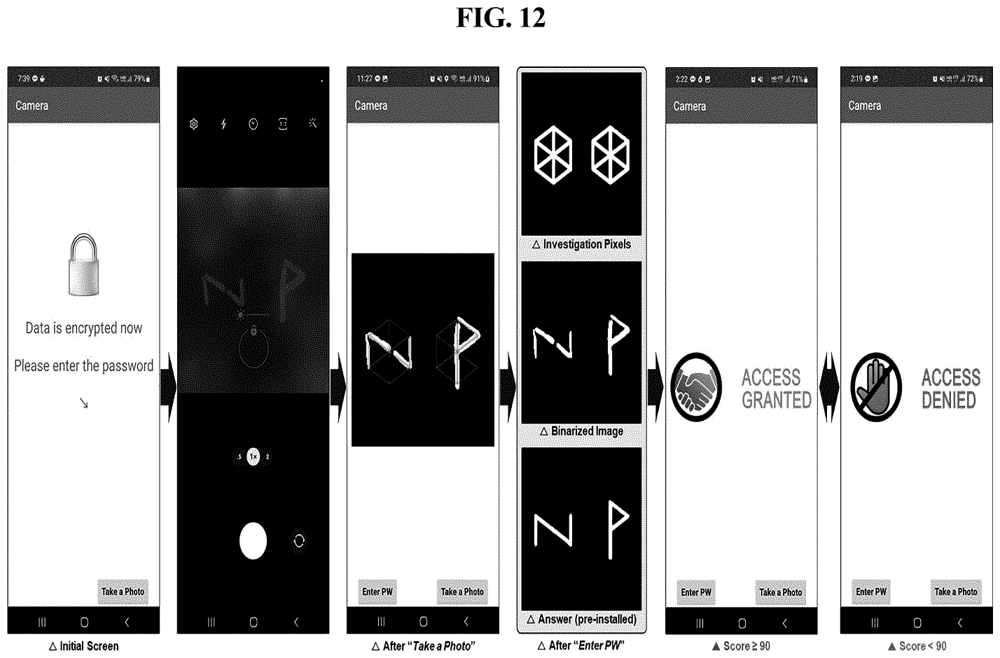

Thereafter, when the user activates the application to access the security system online, the security system of the application may request the user to input a password, for example, such as a “photographing key”, as shown in FIG. 12.

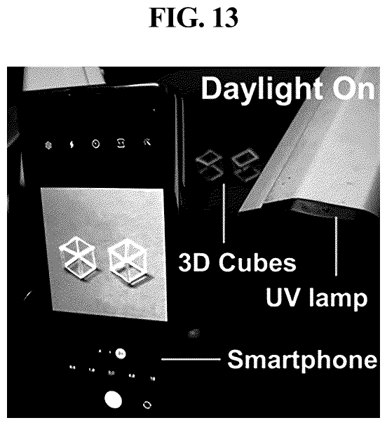

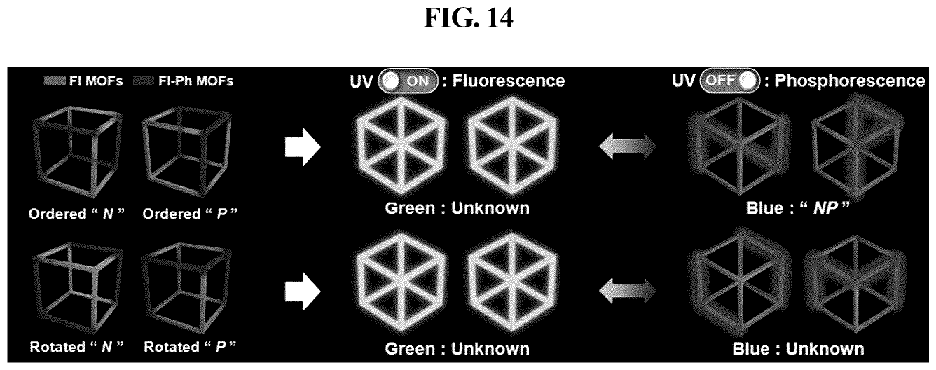

As shown in FIG. 13, the user may adjust the position and angle of the encryption cube according to the three-dimensional encryption pattern, arrange the encryption cubes in order at the correct position and angle, and then turn on the ultraviolet lamp to radiate ultraviolet rays for a certain period of time, for example, 3 seconds. As a result, all twelve cube branches of the cube three-dimensional encryption pattern may emit green fluorescence as shown in FIG. 14.

Thereafter, when the user turns off the ultraviolet lamp, the real information of the NP, that is, the information branches that form the “NP” corresponding to the user's password may emit blue phosphorescence as shown in FIG. 14. As shown in the lower part of FIG. 13, different three-dimensional encryption patterns may be displayed in the case of different arrangements or different cubes.

In this state where the user's mobile phone is activated by the camera activation button linked to the “photographing key” of the security system, an encryption cube in which the real information emits phosphorescent light may be photographed and transmitted to the security system. In this case, the photographed information may be provided as binary information, for example, with the information branches being labeled “1” and the camouflage branches being labeled “0”.

As shown in FIG. 12, a comparison of the registered encryption patterns may be performed in the security system, and a matching rate may be calculated according to an accordance rate. In this case, the matching may be performed not only for the information branch, that is, the information branch “1” in which phosphorescence is emitted, but also for the camouflage information “₀” in which phosphorescence is not emitted.

The matching rate may be calculated according to the degree of the accordance as a result of the comparison. For example, when it matches, it may be converted to “1” point, and when it does not match, it may be converted to “0” point, so that the matching rate may be calculated as a score.

When the matching rate calculated in this way is more than or equal to the predetermined value, the security may be released as matching success, and when the result of calculating the matching rate is less than the predetermined value, it may be displayed as matching failure on the application displayed on the user terminal, that is, the mobile phone.

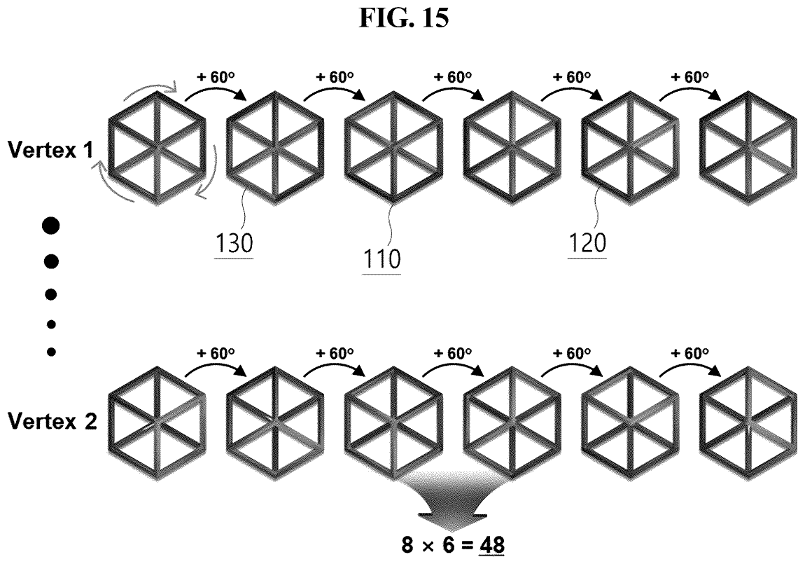

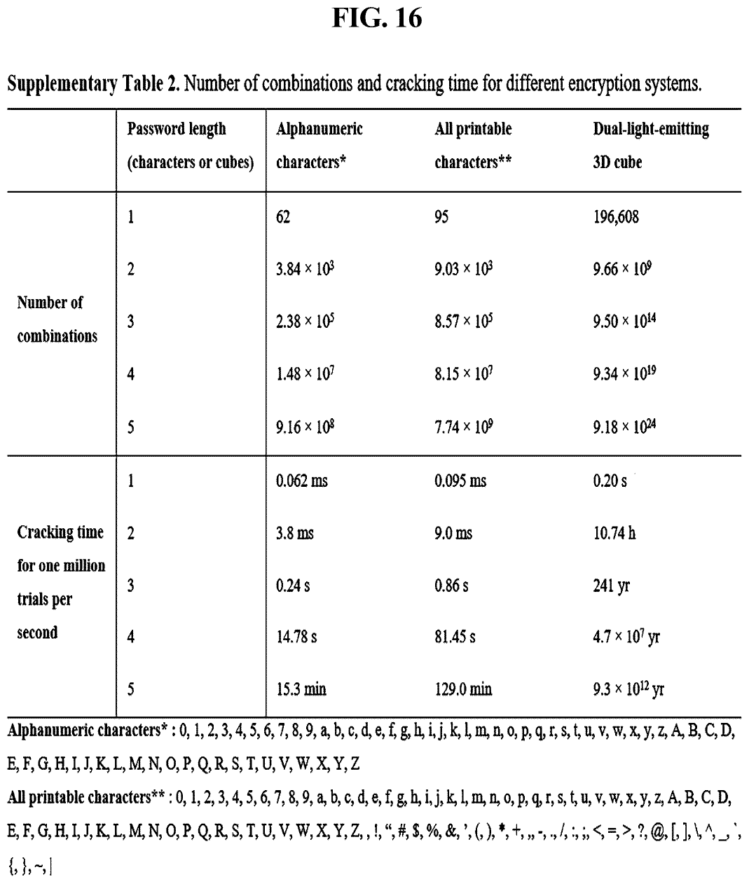

According to the three-dimensional security method using the duel-light-emitting encryption cube according to the present disclosure described above, six patterns may be possible at an angle of 60 degrees for each of eight vertices as shown in FIG. 15. That is, 48 patterns may be possible for each encryption cube. In addition, two probabilities may be included according to binarized “1” and “0”. Referring to FIG. 16, the number of encryption cases may astronomically increase depending on the number of encryption cubes, so that cracking takes more than 200 years even on the existing high-performance computers. Accordingly, it may be possible to obtain a remarkably improved security effect compared to the conventional works according to the three-dimensional security method using the dual-light-emitting encryption cube according to the present disclosure described above.

The present disclosure may not be limited except in the appended claims and the equivalents. With respect to various functions performed by the above-described components or structures (assemblies, devices, circuits, systems, etc.), the terms used to describe these components (including references to “means”) may be intended to correspond to any component or structure that performs certain functions of the described components (i.e., functionally equivalent) even when not structurally identical to the disclosed structures performing functions in the exemplary implementation of the present disclosure illustrated herein unless otherwise indicated.

In addition, the scope of claims below may be included in the detailed description, and each scope of claims may exist on their own as separate exemplary embodiments. Although each claim may exist by itself as a separate exemplary embodiment (even when the dependent claim may refer to a specific combination with one or more other claims in the scope of the claim), other exemplary embodiments may also include combinations of subject matter and dependent terms of claims that are dependent or independent of each other. These combinations are proposed herein unless it is stated that no particular combination is intended. It may also be intended to include the features of the claim for any other independent claim, even when this claim is not directly subordinate to the independent claim.

It should be noted that the methods disclosed herein or in the claims may be implemented by an apparatus having means for performing each of the operations of these methods.

It should also be understood that the disclosure of multiple acts or functions in the specification or claims may not be construed as being in a particular order. Therefore, disclosure of a plurality of operations or functions will not be limiting them to a particular order unless such operations or functions are interchangeable for technical reasons. In addition, in some exemplary embodiments, a single action may include a plurality of sub-actions or may be divided into a plurality of sub-actions. Unless explicitly excluded, these sub-actions may be included and may be part of the initiation of this single action.

The instructions may be executed by one or more processors, such as a central processing unit (CPU), a digital signal processor (DSP), a general-purpose microprocessor, an application-specific integrated circuit (ASIC), a field programmable logic array (FPGA), or other equivalent integrated or discrete logic circuits. Thus, the term “processor” used herein may refer to any one of the above-described structures or any other structure suitable for the implementation of the technology described herein. Also, in some aspects, the functions described herein may be provided in dedicated hardware and/or software modules. In addition, the technology may be fully implemented in one or more circuits or logic elements.

Thus, the techniques described in this disclosure may be implemented, at least in part, in hardware, software, firmware, or any combination thereof. For example, various aspects of the technology described may be implemented within one or more processors including one or more microprocessors, DSP, ASIC, or any other equivalent integrated or discrete logical circuit, as well as any combination of these elements.

The control unit including the hardware may also perform one or more of the techniques described in the present disclosure. Such hardware, software and firmware may be implemented in the same device or in a separate device to support the various technologies described in the present disclosure. The software may be stored on a non-transitory computer-readable medium such that the non-transitory computer-readable medium contains a program code or program algorithm stored thereon, and the program code or program algorithm, when executed, may cause the computer program to perform the steps of the method.

Although various exemplary embodiments have been disclosed, it will be apparent to those skilled in the art that various changes and modifications capable of achieving some of the advantages of the concepts disclosed herein may be made without departing from the spirit and scope of the present disclosure. It will be apparent to those skilled in the art that other components performing the same function may be substituted as appropriate. It should be understood that other exemplary embodiments may be used and structural or logical changes may be made without departing from the scope of the present disclosure. It should be noted that features described with reference to specific drawings may be combined with features of other drawings even not explicitly mentioned. Such modifications to the general concept of the present disclosure may be intended to be covered by the appended claims and the legal equivalents.

The order of the above-described steps may be only an example and not limited thereto. That is, the order between the above-described steps may be mutually varied, and some of these steps may be executed or deleted simultaneously.

The description of the present disclosure described above may be for illustrative purposes, and those skilled in the art will understand that the present disclosure may be easily modified into other specific forms without changing the technical idea or essential features of the present disclosure. Therefore, it should be understood that the exemplary embodiments described above are exemplary and not limited in all respects. For example, each component described in a single form may be implemented in a distributed manner, and similarly, components described in a distributed manner may be implemented in a combined form.

The scope of the present disclosure may be represented by the claims to be described below rather than the detailed description, and it should be interpreted that all changes or modifications derived from the meaning and scope of the claims and the equivalent concepts are included in the scope of the present disclosure.

What is claimed is:

1. A dual-light-emitting material, the material comprising:
a porous framework comprising a metal ion and an organic ligand;
an insert body placed in a cavity of the porous framework; and
a nanocrystal containing the metal ion of the porous framework,
wherein the organic ligand is configured to emit a room-temperature organic phosphorescence (RT-OP) and the nanocrystal is configured to emit fluorescence.

2. The material of claim 1, wherein the organic ligand is configured to emit phosphorescence through a Dexter energy transfer with the insert body.

3. The material of claim 2, wherein the organic ligand is a trimesic acid (TMA), the insert body is a cyanuric acid (CA), and the dual-light-emitting material emits the phosphorescence in a solid state.

4. The material of claim 1, wherein the metal ion is Pb²⁺.

5. The material of claim 1, wherein the nanocrystal is a perovskite nanocrystal.

6. The material of claim 4, wherein the nanocrystal is MAPbBr₃.

7. A method of fabricating a dual-light-emitting material, the method comprising:
a step (S100) of preparing a first solution where an organic ligand and an insert body are dissolved;
a step (S200) of forming a porous framework containing the insert body by mixing a metal ion solution with the first solution;
a step (S300) of forming the dual-light-emitting material by mixing a nanocrystal precursor solution with a suspension including the porous framework containing the insert body;
wherein the organic ligand is configured to emit a room-temperature organic phosphorescence (RT-OP) and the nanocrystal is configured to emit fluorescence.

8. The method of claim 7, wherein the organic ligand is configured to emit phosphorescence through a Dexter energy transfer with the insert body.

9. The method of claim 8, wherein the organic ligand is TMA, the insert body is CA, and the dual-light-emitting material emits the phosphorescence in a solid state.

10. The method of claim 7, wherein the metal ion is Pb²⁺.

11. The method of claim 7, wherein the nanocrystal is a perovskite nanocrystal.

12. The method of claim 10, wherein the nanocrystal is MAPbBr₃.

13. A two-dimensional security method using a fluorescent-phosphorescent dual-light-emitting material, the method comprising:
an encryption process comprising
attaching a masking tape to a substrate,
exposing an area for an encryption information to be printed on by patterning the masking tape,
printing on the exposed area the encryption information where a real information is combined with a fake information by printing the real information in a ink mixed by the fluorescent-phosphorescent dual-light-emitting material as well as by printing the fake information associated with the real information in a ink mixed with a fluorescent material, and
removing the masking tape; and
a decryption process comprising
emitting the fluorescence by radiating ultraviolet rays to the encryption information for a predetermined time, and
displaying the real information through the phosphorescence of the real information when a luminescence of fake information stops after an irradiation of the ultraviolet rays stops.

14. A dual-light-emitting encryption cube having a three-dimensional encryption pattern by dual luminescence of fluorescence and phosphorescence, the encryption cube comprising:
eight vertices of a cube; and
twelve cube branches connecting the eight vertices,
wherein an information branch of the encryption cube included in the three-dimensional encryption pattern is composed of a fluorescent-phosphorescent filament, and a camouflage branch of the encryption cube not included in the three-dimensional encryption pattern is composed of a fluorescent filament according to a predetermined three-dimensional encryption pattern, and
wherein the information branch and the camouflage branch are disposed in any one of six external branches forming a cube centered on the vertices and six internal branches connecting the vertices to each contact point of the six external branches.

15. The encryption cube of claim 14, wherein the vertex comprises a vertex branch coupler composed of a porous sphere which forms a plurality of closed holes to which the cube branches are connected, and the vertex branch coupler is composed of the porous sphere in which closed holes are formed in the sphere in three directions: a horizontal axis (x), a vertical axis (y), and a vertical axis (z) orthogonal to a plane formed by the horizontal axis and the vertical axis, such that the cube branch is selectively coupled to each closed hole.

16. The encryption cube of claim 15, wherein the vertex branch coupler is marked by a vertex branch coupling identifier which identifies the vertex branch coupler.

17. A method of fabricating a dual-light emitting encryption cube capable of dual luminescence of fluorescence and phosphorescence, the method comprising:
a step of mixing a fluorescent light-emitting material with a polymer solvent to form a fluorescent solution, and mixing a fluorescent-phosphorescent dual-light-emitting material with a polymer solvent to form a fluorescent-phosphorescent solution, and respectively filling the fluorescent solution and the fluorescent-phosphorescent solution into an engraved pattern of a separately patterned mold;
a step of drying the fluorescent solution and the fluorescent-phosphorescent solution filled in the mold at a room temperature to form a fluorescent filament and a fluorescent-phosphorescent filament respectively;
a step of cutting the fluorescent filament and the fluorescent-phosphorescent filament as much as a predetermined cube branch length of the encryption cube; and
a step of assembling an information branch of the encryption cube included in a three-dimensional encryption pattern with the fluorescent-phosphorescent filament and assembling a camouflage branch of the encryption cube not included in the three-dimensional encryption pattern with the fluorescent filament according to a predetermined three-dimensional encryption pattern.

18. A three-dimensional security method using a dual-light-emitting encryption cube that is three-dimensionally patterned with a fluorescent light-emitting material and a fluorescent-phosphorescent dual-light-emitting material, wherein
the encryption cube is generated as a patterned encryption cube by assembling a cube branch using a fluorescent-phosphorescent dual-light-emitting material with respect to an information branch of the encryption cube forming a three-dimensional encryption pattern and by assembling the cube branch using a fluorescent light-emitting material with respect to a camouflage branch of the encryption cube not included in the three-dimensional encryption pattern according to a predetermined three-dimensional encryption pattern, the three-dimensional security method comprising:
a process of an encryption setting for setting a user's password according to a three-dimensional encryption pattern set between a user terminal and a security device;
a process of inputting the user password at the user terminal, the process comprising:
a step of arranging the information branch and the camouflage branch in a correct position centered on a vertex according to each encryption pattern of the patterned encryption cube while arranging sequentially the encryption cube corresponding to the user password among the pre-patterned encryption cubes,
a step of radiating ultraviolet rays to the encryption cubes arranged sequentially according to the user password during a predetermined time,
a step of photographing the encryption cubes arranged sequentially according to the encryption information after stopping a irradiation of a ultraviolet ray,
a step of generating a password input information by binarizing the information branch and the camouflage branch of each photographed encryption cube, and
a step of transmitting the generated password input information to the security device; and
a process of decrypting the input user password in the security device, the process comprising:
a step of sequentially generating the three-dimensional encryption pattern of the encryption cube on the basis of the binary information of the user password transmitted from the user terminal,
a step of calculating a matching rate by comparing the pattern of the user password registered in the encryption setting process with the generated three-dimensional encryption pattern of the encryption cube, and
a step of releasing security and providing information as a matching success when the matching rate is more than a predetermined value or transmitting a matching failure notification as a matching failure when the matching rate is less than the predetermined value.

19. The method of claim 18, wherein the fluorescent-phosphorescent dual-light-emitting material, which emits dual luminescence of fluorescence and phosphorescence, is based on a lead (Pb)-containing metal-organic framework (MOF) having a trimesic acid (TMA) organic ligand, and the ultraviolet ray is configured to use a UV lamp with a wavelength of 254 nm or less.
